(19) United States
(12) Patent Application Publication
(10) Pub. No.: US 2011/0055289 A1
(43) Pub. Date: Mar. 3, 2011

(54) METHOD AND SYSTEM FOR MANAGING COMPONENT OBJECTS USED IN A PLURALITY OF COMPOSITE OBJECTS

(76) Inventor: Russel Ennis, London (GB)

(21) Appl. No.: 12/875,381

(22) Filed: Sep. 3, 2010

(30) Foreign Application Priority Data
Sep. 3, 2009 (GB) 0915396.6

(51) Int. Cl. G06F 17/30

(52) U.S. Cl. 707/805; 707/E17.005

(57) ABSTRACT

A composite physical object is formed of a plurality of component physical objects, which component physical objects can be used in a multiplicity of composite physical objects and a data management system and method is provided to manage the relationships. A user interface is provided to enable selection of component or composite objects for the addition or removal of component physical objects from the list. Because the relationship between component objects and composite objects is maintained, if a user selects to remove a component physical object from the list, its related component physical objects to be used in a composite object can be identified and also automatically removed. Similarly, operating the other way around, a user can select a composite object to be removed and this will result in the removal of all component physical objects in the list which are used in the composite object.

### FIELD OF THE INVENTION

The present generally relates to a method and system for managing component object data represented as a list identifying component physical objects that can be used in a plurality of composite physical objects. In one aspect the present invention has particular utility in the management and ordering of component products used in the formation or manufacture of composite products.

### BACKGROUND OF THE INVENTION

There are many situations in which it is necessary to manage a list of component parts or products which can be used in many different and overlapping composite articles. For example, in the motor manufacturing industry many component parts used in the construction of a motor vehicle are used in many different motor vehicles. When a manufacturer wishes to identify or order component parts which are required in order to build a variety of motor vehicles, this presents a data management problem.

A similar situation can arise for many other products such as vacuum cleaners or “white goods” e.g. refrigerators, washing machines, tumble driers etc.

In the catering field, a similar problem can arise when dishes are prepared from recipes requiring component ingredients. Ingredients can be common to many recipes. This applies at a commercial scale as well as a domestic scale.

An object of the present invention is to provide an improved method of managing data relating components to multiple compositions which can contain those components.

### SUMMARY OF THE INVENTION

The present invention provides a computer implemented method and system managing component object data represented as a list identifying component physical objects that can be used in a plurality of composite physical objects. Composite object data structures are stored in a storage system. Each composite object data structure links data for a composite physical object to a component object data structure for each of a plurality of component physical objects used in the composite physical object. A user interface is provided to display the list of component physical objects and composite object data structures linked to the displayed list of component physical objects to enable a user to select composite object data structures and component object data structures to modify the list, and to enable a user to select stored composite object data structures to form or add to the list. When a user selection of a displayed composite object data structure is received the list is modified to remove component physical objects identified by links in the selected composite object data structure. When a user selection of a stored composite object data structure is received the list is modified to add component physical objects identified by links in the selected composite object data structure. When a user selection of a component object data structure represented as a component physical object in the list is received the composite object data structure linked to the selected component object data structure is used to identify other component physical objects in the list used in the composite physical object and to remove the identified component physical objects from the list, or the composite object data structure is modified in accordance with the removal or modification of the selected component object structure.

Thus in accordance with the present invention, a composite physical object is formed of a plurality of component physical objects, which component physical objects can be used in a multiplicity of composite physical objects and a data management system is provided to manage the relationships. A simple user interface is provided to enable selection of component or composite objects for the addition or removal of component physical objects from the list. Because the relationship between component objects and composite objects is maintained, if a user selects to remove a component physical object from the list, its related component physical objects to be used in a composite object can be identified and also automatically removed. Similarly, operating the other way around, a user can select a composite object to be removed and this will result in the removal of all component physical objects in the list which are used in the composite object.

In one embodiment at least one stored composite object data structure links to at least one other composite object data structure as a daughter composite object data structure to form a hierarchical data structure. In this embodiment the user interface can display the hierarchical data structure and a user selection of a displayed daughter composite object data structure when received can enable this to be modified to remove component physical objects identified by linking to the selected daughter composite object data structure.

Thus in this embodiment, composite physical objects can themselves be formed of sub-composite physical objects and thus the relationship between component physical objects and sub-composite physical objects for composite physical objects can be managed using the data structure and provided user interface.

In one embodiment, templates for a plurality of composite object data structures are stored in a template memory. A selection of a template is received from a user or a processor makes an automatic selection of a default template, the composite object data structure is generated linked to component object data structures and the generated composite data structures are stored in the storage system. In this embodiment templates can be generated and stored in the template memory.

Thus in accordance with this embodiment of the present invention templates can be provided for composite physical objects in an abstract form which require parameters to be defined in the template to complete a definition of the required component physical objects for the composite physical object.

In another embodiment of the present invention, quantities are included in at least one said composite data structure and at least one said component object data structure, and the list identifies quantities of the or each component physical object for the at least one component object data structure.

Thus, the data structure for a composite object can define the quantity such as the number, weight, or volume for each component physical object used in or required in the manufacture of a composite physical object.

In one embodiment, at least one composite object data structure includes a scaling factor to be applied to at least one component object data structure to scale the quantity identified in the list for the at least one component physical object according to the scaling factor.

Thus, in this embodiment, although the composite data structure normally requires a set quantity of each component physical object, the number of composite physical objects or the amount of the composite physical object can be increased by a scaling factor which is propagated through to the component physical objects.

In one embodiment, the units of measurement are included in at least one composite object data structure and at least one component object data structure and the list identifies the units for the or each component physical object for the at least one component object data structure.

Thus, in this embodiment, units of measurement such as units of length, units of weight and units of volume ensure the proper composition of a composite physical object by component physical objects. Where different units are used in the data structure, unit mapping data is stored to map between different units. The mapping data can be used to convert units used in the composite object data structure and/or the component object data structure.

Thus, for example when a composite object data structure defines a requirement for 5 kilograms of a component physical object for example, the component physical object data structure may define its units in pounds. Thus the unit mapping data can be used to map between kilograms and pounds, or even between different units eg between volume and weight.

In one embodiment, the list identifies like component physical objects used in a plurality of composite physical objects that are aggregated together. When like component physical objects are added to the list they are aggregated together. When like component physical objects are removed from the list they are disaggregated. This embodiment of the present invention avoids duplicate entries in the list for like component physical objects.

In one embodiment of the present invention, user input is received to modify at least one component object data structure for at least one composite object data structure to modify the component physical objects on the list. The provision of the user interface and the provision of the data structures enables a user to interact with the data to modify the data structure at any level. This provides a simple and intuitive method for modifying the component physical objects in the list either by using the data in the list, or by using the composite object data structures.

In one embodiment, the composite object data structures are link listed objects comprising composite objects, said component object data structures are link listed objects comprising component objects, and link data linking the objects is stored in a link data store.

Thus, in this embodiment of the present invention, link lists are used as the implementation method to link objects (lists) together. This provides a simple implementation methodology.

In one embodiment, each component object is instantiated as a commercially available product and the component object data structures identify commercially available products. In this embodiment, an object orientated implementation is used to provide a frame work whereby instances of objects can comprise the data structure representing a composite physical object and component physical object.

In one embodiment, a database of vendor or manufacturer of specific products is used with instantiation rules to instantiate each component object as a vendor or manufacturer specific product.

In one embodiment, user preference data and/or user history data is stored and the instantiation is performed using the stored data.

In one embodiment, at least one component physical object in the list can be automatically substituted based on stored substitution rules. Such rules can for example be defined by the user or by the vendor or manufacturer. This enables items which are for example unavailable, or which the user would prefer replaced to be automatically substituted.

In one embodiment, the method and system is used for ordering products and the list comprises a list of products to be ordered. The method and system enables the products on the list to be ordered from at least one supplier. The present invention can thus be applied to an ordering system and can facilitate indirect or direct ordering of products.

In this embodiment to the present invention, the component object data structure can include data identifying a supplier for at least one listed product.

In one embodiment, products which are considered to be staple products i.e. products that are normally available to a user wishing to assemble, make or manufacture a composite physical object, are identified in a staple product store and such products listed in the list are identified. This enables the automatic removal of such staple products from the list or it enables a user to select to remove the product from the list. This avoids the automatic reordering of staple products unnecessarily.

In one embodiment, at least one composite object structure includes a date of use of the composite physical object, at least one product in the list has a used by date, and the ordering is made dependent upon the date of use and the use by date.

Thus, this embodiment of the present invention is applicable to perishable products and to manufacturing processes or composite object production which are required to take place on a certain date or by a certain date. This embodiment avoids the wasteful ordering of products which will be out of date by the time of use of the product.

In one embodiment of the present invention, vendor data is stored identifying at least one vendor or supplier of the products and the ordering is made dependent upon the vendor data. Thus, in this embodiment, a user can select preferred vendors either for all products or for certain products or product types and this can be taken into consideration during instantiation of the data structure.

The present invention can be implemented in many different ways, for example in hardware, software or a combination of both. When the present invention is implemented in software on a computer, the software can be provided to the computer at a computer program on any form of carrier such as storage medium e.g. floppy disk, hard disk, solid state memory device, or optical disk for example, or on an intransient medium such as a signal e.g. a signal over the internet, an electro-magnetic signal, an optical signal, a magnetic signal, an acoustic signal, or a radio frequency signal. The present invention encompasses all forms of the computer program for implementation of the present invention.

### BRIEF DESCRIPTION OF THE DRAWINGS

FIG. 1 is a schematic diagram of a web-based system in accordance with one embodiment of the present invention,

FIG. 2 is a schematic diagram of the provider's server of the embodiment of FIG. 1,

FIG. 3 is a schematic diagram of the implementation logic of the supplier's server of the embodiment of FIG. 1,

FIG. 4 is a diagram illustrating the functionality available to a user through the user interface in accordance with one embodiment to the present invention,

FIG. 5 is a diagram illustrating the instantiation process in accordance with one embodiment of the present invention,

FIG. 6 is a flow chart illustrating a vendor fulfilment process in accordance with an embodiment of the present invention,

FIG. 7 is a diagram of the composite object and component object data structure in accordance with an embodiment of the present invention,

FIG. 8 is a diagram illustrating an instantiated order in accordance with one embodiment of the present invention,

FIG. 9 is a diagram illustrating an instantiated order in accordance with an alternative embodiment of the present invention,

FIG. 10 is a diagram illustrating a three panel user interface in accordance with an embodiment of the present invention,

FIG. 11 is a diagram illustrating the unit and quantity mapping objects,

FIG. 12 is a diagram illustrating the mapping between units A and B via canonical mapping units,

FIG. 13 is a diagram illustrating unit quantity mapping at a high level,

FIG. 14 is a diagram illustrating the data structure relations in accordance with an embodiment of the present invention,

FIG. 15 is a diagram illustrating a composite object to component object relationship example,

FIG. 16 is a diagram illustrating the relationship between List and InstLink structures in accordance in accordance with an embodiment of the present invention,

FIG. 17 is a diagram illustrating an example of GroupLink usage,

FIG. 18 is a diagram illustrating InstLink equivalent costs for item quantisation,

FIG. 19 is a flow chart illustrating instantiation and quantisation, and

FIGS. 20 to 48 are diagrams illustrating the effect of the instantiation process on the data structures.

### DESCRIPTION OF SPECIFIC EMBODIMENTS OF THE INVENTION

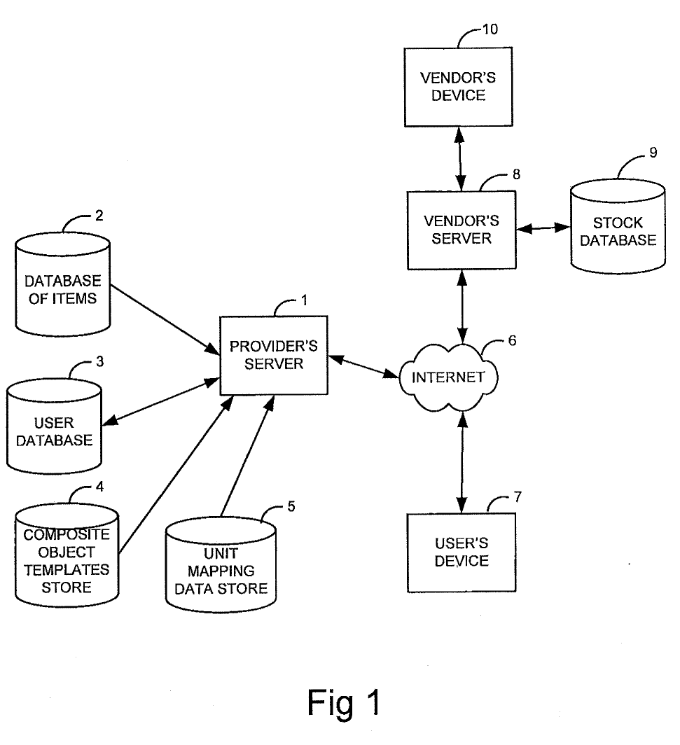

In the specific embodiment of the present invention described with reference to FIGS. 1 to 49, composite objects and sub-composite objects comprise recipes for food items such as meals, cakes and dishes. Sub-composite items can comprise recipes in their own right which form part of a larger recipe such as a recipe for a bolognaise sauce and a recipe for pasta. Component physical objects comprise either generalised products which can be purchased from a specific vendor or manufacturer such as flour, minced beef, or tomatoes. Component physical objects can also comprise food items that can be directly purchased or ordered from a vendor or manufacturer. As such the items must be identified by a brand or vendor. Generally such items will have a product code.

In the specific embodiment described with reference to FIGS. 1 to 49, the aim is to produce a list of items which can be ordered from a vendor. Thus the specific embodiment describes component physical objects as orderable items identifying a brand or vendor. The present invention is however generally applicable to component physical objects which can be identified to either a generalised level or to a specific level.

The composite object data structures linking data for composite physical objects to component object data structures is described in the specific embodiment of FIGS. 1 to 49 as a link list wherein each object comprises a list and link data is formed and stored separately to enable specific instantiations of the object oriented data structure. The present invention however encompasses any suitable data structure to enable the linking of composite object data structures to component object data structures, particularly in one embodiment to facilitate a hierarchical data structure to enable the inclusion of sub-composite object data structures in the overall data structure.

In the specific embodiment of FIGS. 1 to 49, the recipe based ordering system is implemented in a web-based environment providing the user with the ability to use a browser to access a web page served from a server. Other embodiments of the present invention however encompass the implementation of the invention on a stand alone computer or in a distributed data processing system. Further, the present invention can be provided with a bespoke coded user interface to enable a user to interact with the data structures to manage the list of component physical objects. Another possibility is an internet service accessed by a browser plug-in or non-browser-based client application which allows more data storage and processing to be pushed out to the client side of the interaction.

A specific embodiment of the present invention implementing a food ordering/shopping interface for use in a web-based environment will now be described with reference to FIGS. 1 to 49.

FIG. 1 is a schematic diagram illustrating components of the system. A provider's server 1 hosts the processing of the data and the user interface. The provider's server 1 communicates with a database of items 2 containing information on component objects or items for inclusion in the list. Also a user database 3 is provided for exchange of information with the provider's server to store user specific information which includes the data structures formed by the user. Also unit mapping data is provided in a unit mapping data store 5 and this is used for converting units of measurement in the processing of the data structures to convert between units of measurement required in the recipe (composite object data structure) and items (component object data structures) or sub-composite object data structures (sub-recipes). Composite object templates are stored in a composite object template store 4 and these are accessible interactively by the provider's server 1. Composite object templates can comprise template recipes which can be instantiated specifically e.g. chosen for a particular date or used to select specific items for the recipe in place of generalised descriptions of items. The data in databases 2 to 5 will be described in more detail hereinafter with reference to the operation of the system.

The provider's server 1 is connected over the internet 6 to a user's device 7. In use there will be a multiplicity of users accessing the provider's server 1 using multiple users' devices 7. In this embodiment of the present invention, the provider's server hosts a web server and the user's device 7 executes a web browser to access web pages hosted by the provider's server 1. Thus, in this way a user is able to access the service provided and to interact with the data structures.

A vendor's server 8 is provided connected to the internet 6 to enable the provider's server 1 to interface to the vendor's server 8. The provider's server can thus operate with a single vendor or with a multiplicity of vendors. In other words, a user can have access to products either from a single vendor or a multiplicity of vendors. A stock database 9 is connected to the vendor's server 8 to enable orders placed with a vendor to be checked against a stock for availability and delivery. A vendor's interface 10 is provided locally to the vendor's server e.g. over a local area network to enable a vendor to interact with the provision of products.

In an alternative embodiment there is a direct connectivity (LAN or otherwise) between provider's server and the vendor's server (in fact, in some implementations they could be the same device). Such could be the case if the service was provided directly by the vendor, as opposed to as a third-party service.

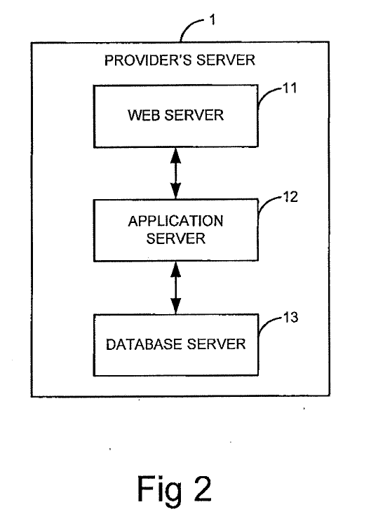

FIG. 2 is a schematic diagram of the software provided on the server's provider 1. A web server 11 such as an Apache server is provided connected to the internet. Application server 12 undertakes the data processing and generates the interactive interface for hosting by the web server 11. A database server 13 is provided for interfacing to the databases 2 to 5.

In this embodiment we are using HTTP as an example transport protocol between the user and the service, but such a choice of transport does not limit the invention. As such, the Apache could be replaced with a custom-built device communicating using a different (perhaps proprietary) protocol between the user equipment and the service.

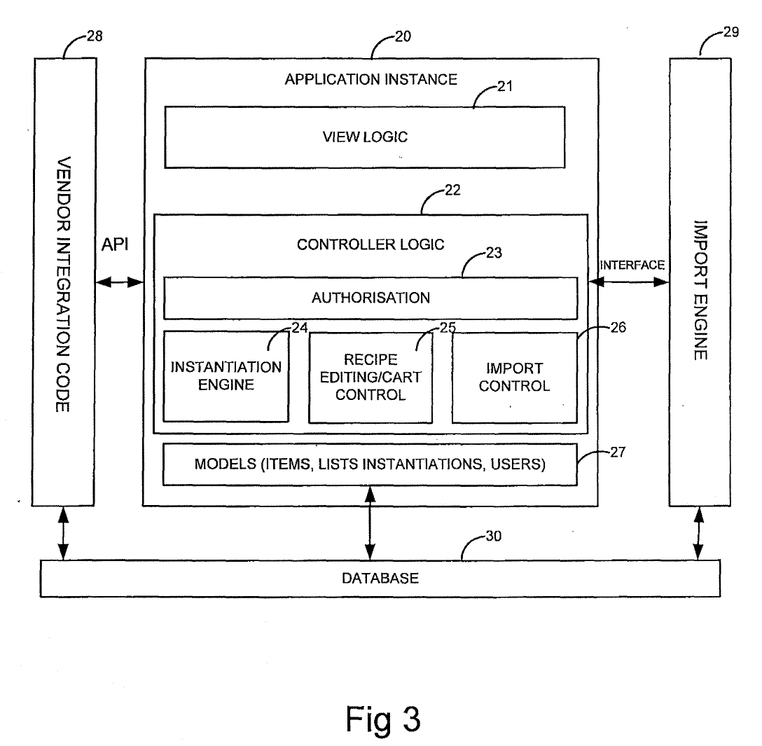

FIG. 3 illustrates in more detail, at a logic level, the operation performed by the software on the provider's server 1. Vendor integration code 28 is provided which is linked by an API to an instance of the application 20 run on the application server 12. In import engine 29 is also provided interfaced to the application instance to enable the importing of recipes (composite physical objects) as templates for use in the formation of recipe instances. The databases 2 to 5 are represented in a generalised view and database 30 in FIG. 3. Within the application instance 20, the user interface is provided by view logic 21. Models of items, list instantiations and users 27 is provided from data read from the database 30. Control logic 22 operates to process the data in accordance with selections and instructions received via the view logic 21. A control logic 22 also includes authorisation logic 23 for performing conventional user authentication/authorisation. Logic is included as an instantiation engine for performing the instantiation, which will be described in more detail below. Logic is also provided for recipe editing and cart control 25. Further logic 26 is provided for import control to control the importing of recipes via the import engine 29.

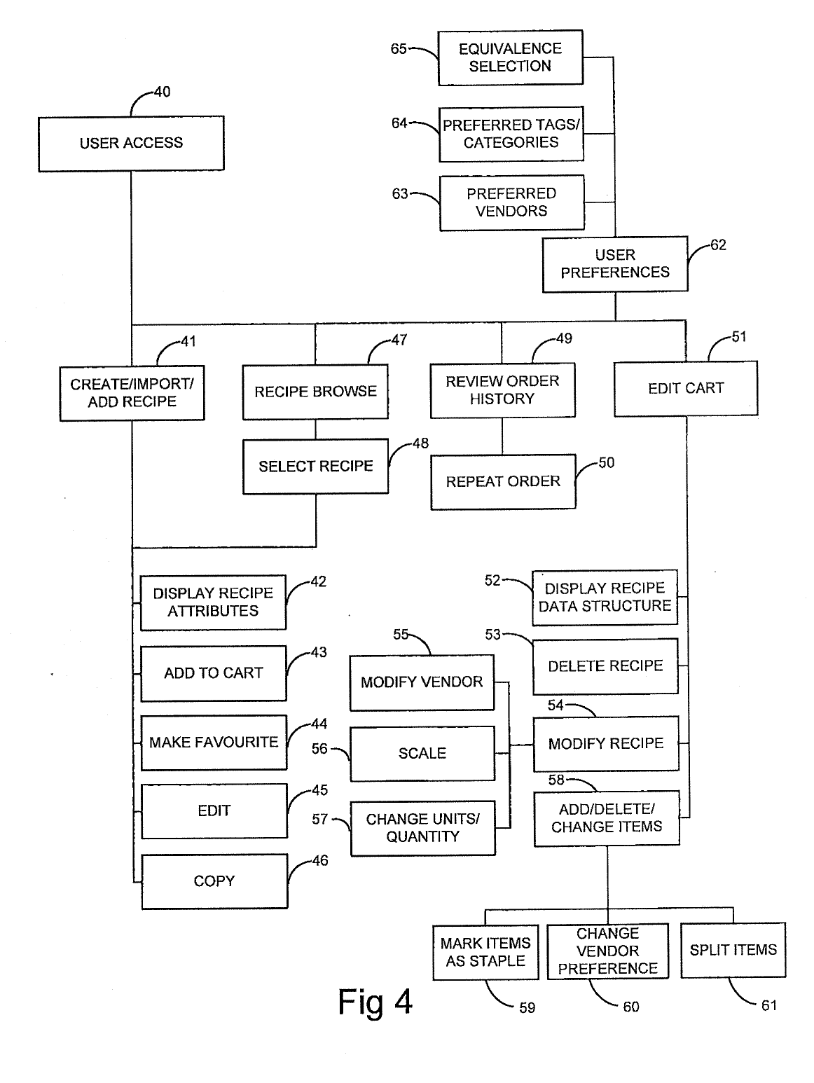

An overview of the operation of the system by interaction of the user with the user interface will now be described with reference to FIG. 4.

When a user accesses the initial web page they may log in to benefit from features like preferences and user history, and it is required for purchasing. To log in, the user will enter their user name and password and this will be validated using information stored in the user database 3. Once a user is logged in, their user ID is identified. This will give them access to data stored for them in the user database which will include an order history for previous orders made, a current cart identifying a list of items currently awaiting ordering, user preferences, and recipe templates. Other users who have not logged in are recognised by a session-based token.

A user is able to create, import, or add a recipe (41). This can be achieved by starting a completely new recipe, selecting a previous recipe instantiation by browsing through previous recipes (47) and selecting a recipe (48) or by selecting a recipe template which is a generalised recipe.

Recipe templates can be provided in the database 4 as personal recipes, or recipes that can be shared with others. The sharing can be by private sharing with set individuals or by publicly sharing the recipes widely. When a recipe instance is created from a recipe template, data linking and identifying the origin of the recipe template or modified recipe are kept as will be described in more detail below.

When a recipe is being modified, recipe attributes are displayed (42) so that these can be modified if required. Such attributes includes an identification of the items, quantities, units of measurement, a description, who the recipe is owned by (i.e. the originator of the recipe), who the recipe is created by, whether the recipe is public or not, and any scaling to be applied to the recipe. The scaling that can be applied to recipes will be described in more detail below.

A user can select to edit the recipe (45) to modify the attributes. Generally a new instance of the recipe will be created although it is possible to replace the current instance. The editing of the recipe can take any form including the changing of the name, the changing of the quantities or units, or changing of the scaling. Also, since the recipe optionally includes a date of use of the recipe as well as a date of creation, the editing can be used to change the date of use of the recipe. Thus a user can select a recipe and choose the date on which the recipe is to be made. This date is useful for the ordering of items where the date of use of a recipe can be compared with the sell-by date of items to be ordered.

A user can also select to make the recipe a favorite (44) in which case the recipe is stored to enable its latest selection. A user can also select to add the recipe to the cart (43). If a user does select to add the recipe to the cart, all of the items of the recipe instantiation are added to the list of items in the cart.

After the user logs in they can also select to review their order history (49). From this they can make simple repeat orders (50) so that they can for example make repeat orders weekly and include common weekly recipes.

When a user logs in they are also able to view user preferences (62). This enables the user to select preferred vendors (63), preferred tags or categories (64) and make equivalent selections (65). The user can select a vendor as a preferred vendor for all of the items. Alternatively, a user can select a vendor as a preferred vendor for only certain type of items. Tags and categories can be used to mark items to enable their selection. For example items can be tagged as organic, wheat-free, free-range, healthy option, low-fat, nut-free etc. Thus a user can select for example to preferably order organic items for recipes. When tags are used, items are individually tagged to enable their identification to meet the preferred tags during the instantiation process as will be described in more detail hereinafter.

With regard to equivalents selection (65) a user is able to identify items which they consider equivalent to other items together with an equivalents factor to enable the instantiation algorithm to identify potential substitution possibilities when certain items are unavailable for example. The equivalents can be identified between items (i.e. the component object data level) or between sub-recipes or recipes (i.e. at the composite object data level).

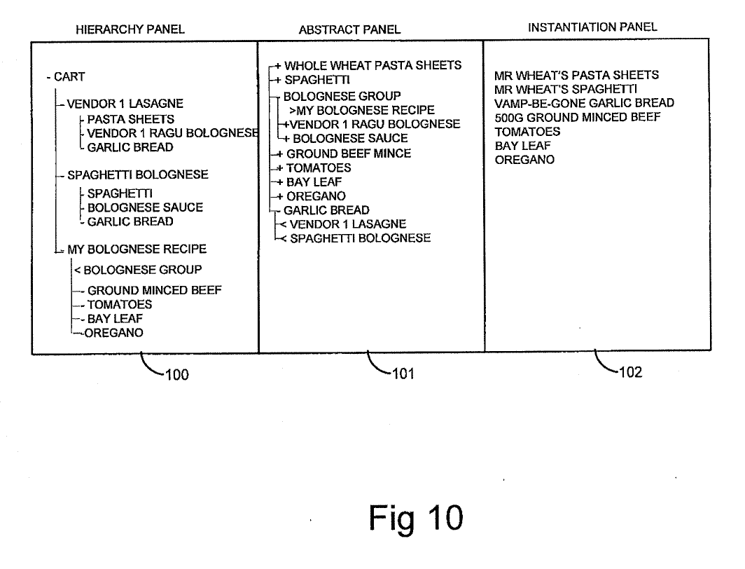

On the user interface a user is able to view and edit the cart (51). They can display the recipe data structure (52) as will be described in more detail with reference to FIG. 10. They can select to delete a recipe (53) modify a recipe (54), or add, delete or change items in the list (58). The recipe can be modified at any level i.e. at the recipe or sub-recipe level. A vendor selected for the recipe as the preferred vendor for the items in the recipe can be modified (55). A scaling factor used in the recipe can be modified (56). Also units and/or quantities can be changed in the recipe (57).

Items can be marked as staple items (59). Staple items are items that are considered to be a staple product that most users will have a supply of and thus need not be included in every order. Such a staple items might for example be salt. Data identifying selected staple items will be stored so that in future instantiations of the recipes to form items in a cart, either staple items will automatically be omitted, or the user interface can display a notice to the user to enable them to select to include or exclude the staple item required for a recipe.

Items can include identifiers indicating a user's preferred vendor and thus a user can select to change a vendor preference (60) for a selected item in the cart.

For an item having a certain quantity associated with it, the item may be required in more than one recipe. The instantiation process enables the aggregation of the quantities together to provide a single entry in the cart. However, the user may wish to manually split the items (61) and this is possible using the user interface for the cart.

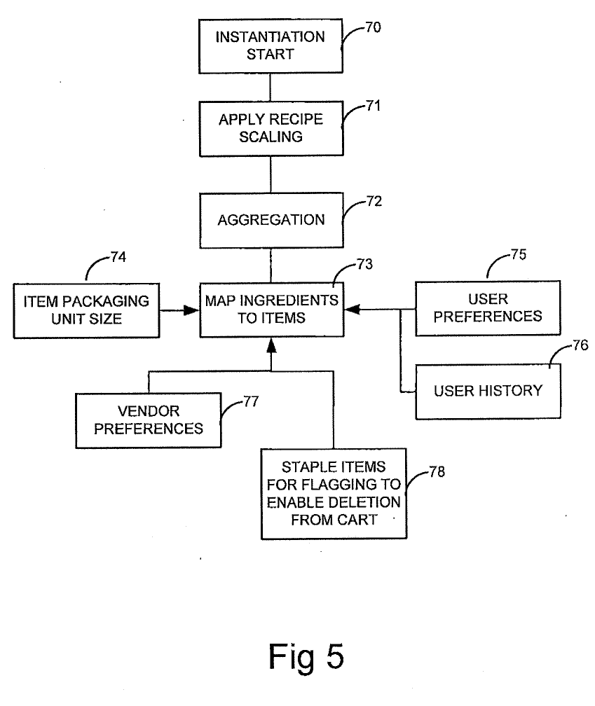

FIG. 5 illustrates the instantiation process in outline. When the instantiation process starts (70) a number of factors are applied by the instantiation algorithm and the order is dependent upon the algorithm implemented. Recipe scaling (71) is applied to determine the correct quantity of items to meet the scaling applied to the recipe. Aggregation occurs for items in the list of the cart to avoid duplicate entries of the items in the list for items which appear in more than one recipe (72). Generalised abstract ingredients for recipes are then mapped to ingredients (73). For example, “500 grams of flour” is mapped to “500 grams of Vendor 1 Value Flour”. In the mapping process the packaging unit size of the items (74) is taken into consideration together with user preferences (75), user history (76) and vendor preferences (77). Further, staple items are identified in the cart and these are either deleted or flagged for the attention of the user to enable the user to either select to include the staple item in the cart or remove it (78).

FIG. 5 merely gives an outline of the instantiation process and more details of the instantiation process will be given below.

In this embodiment of the present invention, the hierarchical data structure is maintained in the shopping cart to enable modification of the shopping cart and the placing of orders with vendors. In one embodiment of the present invention, this data structure is maintained in the data provided to vendors so that a vendor is able to interact with the data during the vendor fulfilment process i.e. the supply and delivery of the required ordered items.

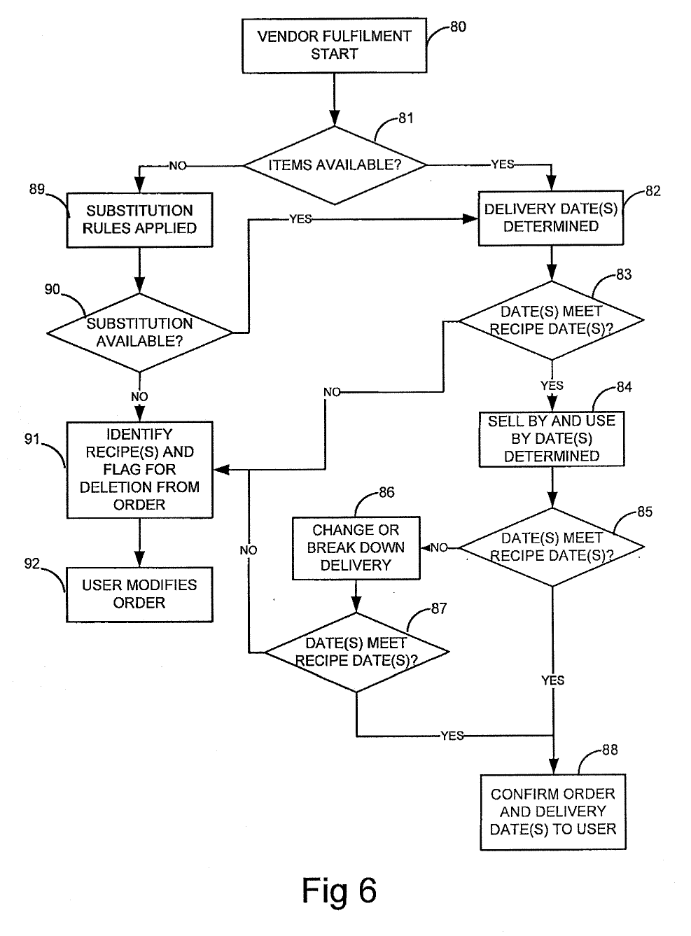

FIG. 6 is a schematic diagram of a fulfilment process in accordance with one embodiment of the present invention. A fulfilment process starts at step 80. In step 81 the vendor server 8 determines from the stock data base 9 whether the ordered items are available. If the ordered items are available, a delivery date is determined or delivery dates are determined (step 82). More than one delivery date may be determined where certain products are not available for some time and thus a split delivery may be required.

The recipes contain data identifying the dates on which the recipes are to be used. Thus in step 83 as part of the fulfilment process a matching algorithm can be used to determine whether the delivery dates will meet the requirements of the recipe. If in step 83 it is determined that the delivery dates meet the requirements of the recipes, the sell by and use by dates of the items are determined in step 84 and a matching algorithm can then be applied to determine whether these meet the requirements of the recipes in step 85. For example, an item that has been aggregated from two recipes that have use dates five days apart may have a use by date of three days after opening. Thus clearly the aggregated item will not match the recipe dates since it will perish before the second use in the second recipe.

If it is determined that the sell by and use by dates do meet the recipe dates in step 85, in step 88 the order is confirmed to the user with the delivery dates and options presented to aggregate anyway, or to split items and/or split deliveries.

If in step 81 it is determined that the required items are not available, in step 89 substitution rules are applied. Substitution rules can include user substitution rules in which a user has specified items which are considered equivalent and their equivalence rating. Also vendor substitution rules can be applied whereby a vendor can identify recommended alternatives. In these rules generally the user substitution rules will override the vendor substitution rules. If it is determined that a suitable substitution is available in step 90, the process moves to step 82 to determine delivery dates. If no substitutions are determined to be available, the recipes including the items for which no substitutes can be determined are flagged for deletion from the order in step 91. This information is then presented to the user in the user interface to enable a user to modify the order. Such a modification can include the removal of the recipe or the modification of the recipe. It can also include simply the change of date of the recipe.

If in step 83 it is determined that the dates for delivery do not meet the recipe dates, in step 91 the recipe is identified to the user for deletion from the order or for modification.

If in step 85 it is determined that the sell by or use by dates do not meet the recipe dates, in step 86 the user is given the opportunity in the user interface to change or break down the delivery. Alternatively, the vendor may opt to try to change or break down the delivery to meet its own delivery dates and recipe dates. It is possible that an automated algorithm could undertake this process. If the changed or broken down delivery has sell by and use by dates and delivery dates which meet the recipe dates, in step 87 the order is confirmed together with the delivery dates to the user in step 88. If the changed or broken down delivery has delivery dates and sell by and use by dates which do not meet the recipe dates in step 87, in step 91 the recipes are identified and flagged for deletion or modification in the order or the user could confirm delivery anyway, ignoring the conflict.

The order of processing described with reference to FIG. 6, is only one example and the process is algorithm dependent.

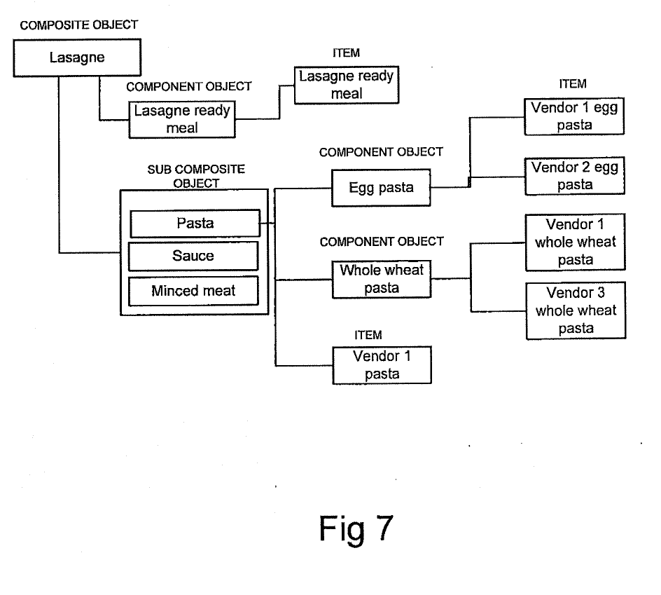

FIG. 7 is a diagram illustrating in an abstract form how data can be hierarchically organised in order to represent a recipe for lasagne with two alternative instantiations, as a ready meal or as a collection of ingredients.

The composite object comprises lasagne. A component object related to this recipe can comprise a lasagne ready meal. This has a particular instantiation as a lasagne ready meal item which is available as a branded product or a product from a specific vendor.

The composite object lasagne may also be provided for in the abstract by a sub-composite object in the form of a recipe comprising the component objects pasta, sauce, and minced meat. In FIG. 7 the component object pasta is shown instantiated as a component object egg pasta, a component object whole wheat pasta, and an item Vendor 1 pasta. Thus one particular instance of the recipe Lasagne could be instantiated directly as the item Vendor 1 pasta instantiating the Pasta component object, plus suitable Sauce and Minced Meat object instantiations (not shown). Another instantiation could lead to the component object egg pasta which can be instantiated either by the item Vendor 1 egg pasta or the item Vendor 2 egg pasta. A different instantiation of the recipe can require the component object whole wheat pasta that can be instantiated either as Vendor 1 whole wheat pasta or Vendor 3 whole wheat pasta.

As can be seen in FIG. 7, the data structure provides flexibility for defining the relationship between items which are specific instances of component objects, and recipes which comprise composite objects. Modifications to recipes can take place at any point in the hierarchy. The items comprise a list of items which can be provided in a cart for ordering and can thus be easily managed using this hierarchical arrangement.

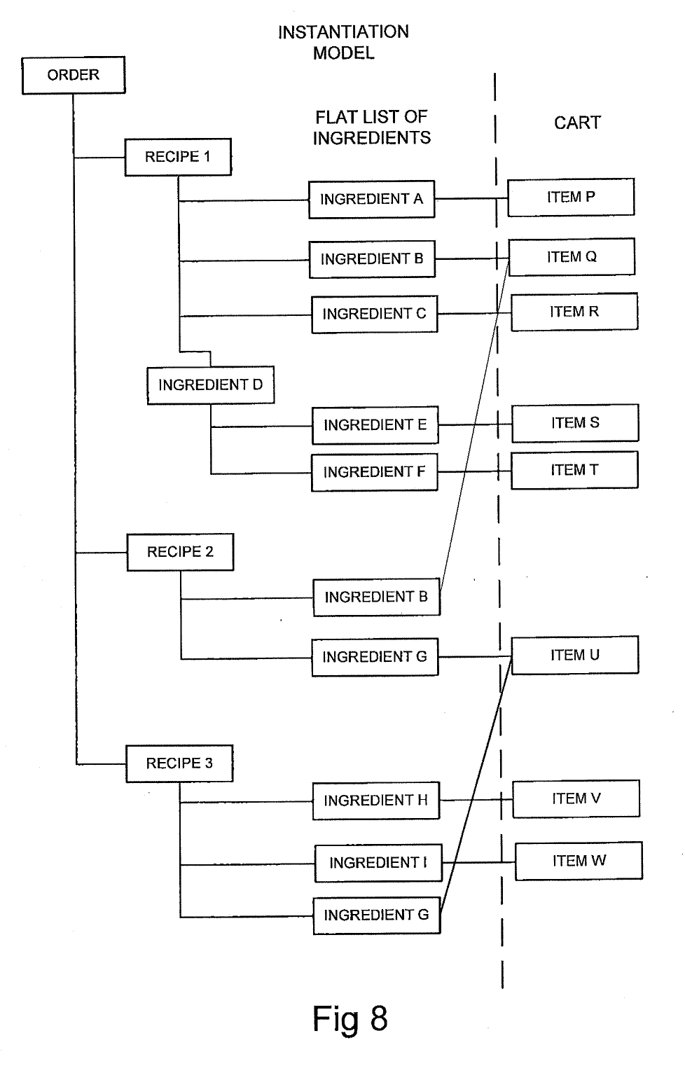

FIG. 8 illustrates one embodiment of the present invention utilising an instantiation model for an order which comprises three recipes. In the first recipe ingredients A, B and C are required which comprise component objects. Ingredient D comprises a composite object which is broken down into component objects E and F to provide a flat list of ingredients. Recipe 2 requires ingredients B and G. Recipe 3 requires ingredients H, I and G. Thus the list of ingredients includes duplicate ingredients.

In this embodiment of the present invention, the instantiation process instantiates the ingredients into items in the list in the cart by aggregating common ingredients which includes summing up the required quantities and insuring common units of measurement and mapping these two the required number of items to meet the needs of the recipes.

In the embodiment of FIG. 8, the instantiation takes the form of instantiating a general description of ingredients to specific vendor items in the cart.

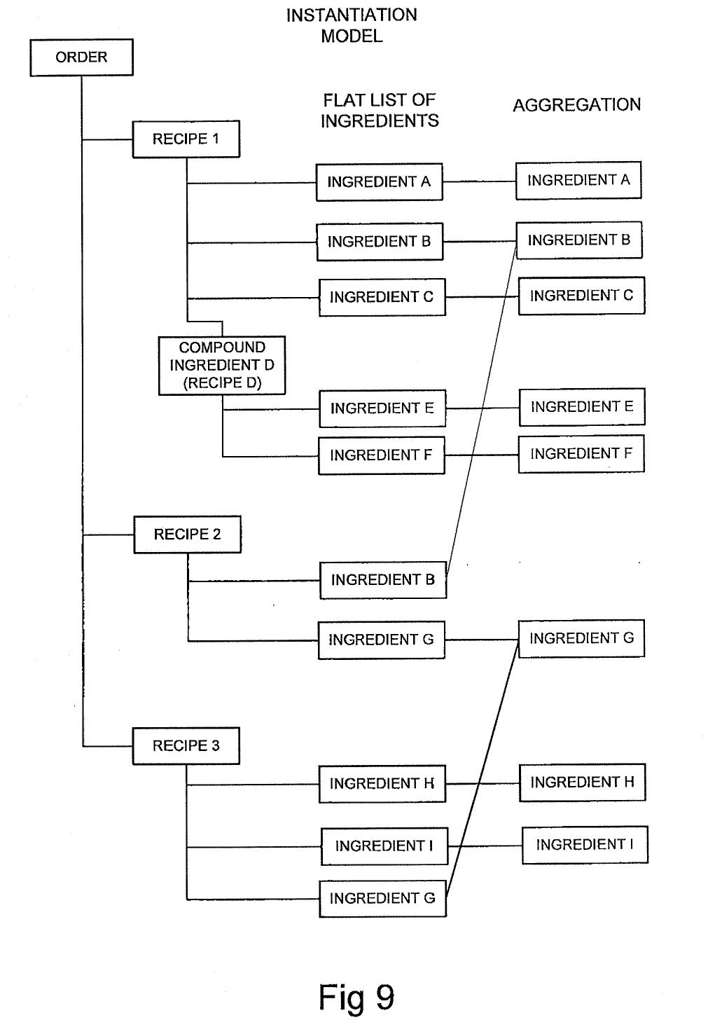

FIG. 9 illustrates an alternative embodiment in which the instantiation model simply provides a list of ingredients at a more general level e.g. 500 grams of flour, without defining a vendor or manufacturer specific item. This embodiment of the present invention is not suited to a direct ordering process from a vendor or manufacturer. It does however provide a flat list of aggregated ingredients which can be used by a user to place an order manually.

The operation of the user interface will now be described with a view to describing the views for the cart which are available to the user.

FIG. 10 illustrates a “triple view” showing the links between the hierarchy, abstract items and instantiated items. The instantiation panel 102 is the vendor item panel identifying the items in the list of the cart.

The hierarchy panel 100 is an abstract item view presented as an expandable tree showing the hierarchy of abstract items where each abstract item which comprises a composite object can be expanded or contracted. The abstract panel 101 shows abstract items currently under consideration. In this panel items can be grouped such as the Bolognese Group. Also garlic bread is shown as being used in two different recipes.

The process arriving at the display of FIG. 10 will now be described.

The user adds the list items “Vendor 1 Lasagne” and “Spaghetti Bolognese” to their cart and brings up the user interface FIG. 10 to see how they are instantiated. The lists are made up of the items shown as their children in the hierarchy panel.

To start with, the abstract panel shows just the five combined ingredients (the common “Garlic Bread” was automatically grouped, as it was the same item in the two recipes). Expanding the “Garlic Bread” mode in the abstract panel shows two references to the two recipes that require it.

The instantiation panel initially shows three items, the pasta sheets, spaghetti, and Vendor 1 Ragu Bolognese. The “Bolognese Sauce” and “Garlic Bread” abstract items are not automatically instantiated because the instantiation engine was unable to guess what vendor items they should be (they have not previously been instantiated by anyone at this vendor).

As a result the “Bolognese Sauce” and the “Garlic Bread” items in the abstract panel require instantiation. They must be instantiated to allow checkout. The user selects the “Garlic Bread” in the hierarchy or abstract panel and selects to add a vendor item which selection comprises “Vamp-be-gone Garlic Bread”. This then appears in the instantiation panel.

The user does not want to make two separate Bolognese sauce purchases, so they select the “Vendor 1 Ragu Bolognese” and “Bolognese Sauce” items and group them as “Bolognese Sauce”. The two original items disappear as children of the new group item (the node can be expanded to show the original items that have been grouped).

The “Vendor 1 Ragu Bolognese” stays in the instantiation panel, but is rescaled to satisfy both recipes Bolognese requirements (it is the largest subset of the grouped object that already has an instantiation, so its instantiation is used by default).

The user wants to make the sauce at home, rather than buy a bottle, so they reinstantiate the abstract item “Bolognese Group” as the recipe “My Bolognese Recipe”. This is an abstract item rather than a vendor item, so it appears as a new item below the cart in the hierarchy panel with a reference to the Bolognese Group. The Bolognese Group similarly has a reference to “My Bolognese Recipe”. The “vendor 1 Ragu Bolognese” disappears from the instantiation panel as it has been replaced by “My Bolognese Recipes” instantiated items.

“My Bolognese Recipe” had been purchased before, so it automatically instantiated with the details from the last purchase, scaled to fit the number of portions required currently.

Continuing with the lasagne example, features of embodiments of the invention will be discussed below with reference to this specific example.

Table 1 below illustrates the data structure for an original example order.

TABLE 1
Original example order

| Abstract Shopping List | Instantiated List | |
|---|---|---|
| Hierarchy | Hierarchy | Flat Shopping List |
| 3 × Lasagne | 3 × Lasagne | 600 g fatty ground beef |
| (scaled to 2 portions) | (scaled to 2 portions) | 400 g lean ground beef |
| with Budget mapping | with Budget mapping | 10 sheets of lasagne |
| 3 × 200 g ground | 600 g fatty ground | dried pasta |
| beef | beef | |
| 3 × 2 sheets of | 6 sheets of | |
| lasagne dried | lasagne dried | |
| pasta | pasta | |
| 1 × Lasagne | 1 × Lasagne | |
| (scaled to 4 portions) | (scaled to 4 portions) | |
| with Luxury mapping | with Luxury mapping | |
| 1 × 400 g ground | 400 g lean ground | |
| beef | beef | |
| 1 × 4 sheets of | 4 sheets of | |
| lasagne dried | lasagne dried | |
| pasta | pasta | |

The right side maps to a traditional flat list shopping cart of “600 g fatty ground beef, 400 g lean ground beef, 10 sheets lasagne dried pasta”. The level 2 bullet points in the Instantiated List Hierarchy above represent the actual purchased items (resulting in the traditional flat list shopping cart shown in the third column). However, the additional structural information allows the following user interactions, as will be discussed below:
Rescaling a recipe/sub-list
Removing a recipe from the list
Changing how a given recipe is instantiated, without affecting other uses of the same underlying ingredients.
   Considering now the ability to rescale the recipe, the User rescales Luxury lasagne meal to 6 portions (more people coming over for dinner than previously thought when starting shopping). The User can simply enter a new number of portions for that recipe in the UI, and the vendor order instantiation mechanism does all the work to rescale the purchases of just those ingredients.

Table 2 shows the resulting data structures.

TABLE 2
User rescaled Luxury lasagne from 4 to 6 portions

| Abstract Shopping List | Instantiated List | |
|---|---|---|
| Hierarchy | Hierarchy | Flat Shopping List |
| 3 × Lasagne | 3 × Lasagne | 600 g fatty ground beef |
| (scaled to 2 portions) | (scaled to 2 portions) | 600 g lean ground beef |
| with Budget mapping | with Budget mapping | 12 sheets of lasagne |
| 3 × 200 g ground | 600 g fatty ground | dried pasta |
| beef | beef | |
| 3 × 2 sheets of | 6 sheets of | |
| lasagne dried | lasagne dried | |
| pasta | pasta | |
| 1 × Lasagne | 1 × Lasagne | |
| (scaled to 6 portions, | (scaled to 6 portions) | |
| formerly 4) | with Luxury mapping | |
| with Luxury mapping | 600 g lean ground | |
| 1 × 600 g ground | beef | |
| beef | 6 sheets of | |
| 1 × 6 sheets of | lasagne dried | |
| lasagne dried | pasta | |
| pasta | | |

The right side now maps to a traditional flat list shopping cart of “600 g fatty ground beef, 600 g lean ground beef, 12 sheets lasagne dried pasta”. The key point to note is that the additional structural information allowed the vendor system to determine that to rescale the Luxury lasagne meal from 4 portions to 6 portions (a 50% increase), it needed to increase the lasagne dried pasta order from 10 sheets to 12 sheets (a 20% increase). It could do this because the vendor system contained structural information relating how the original 10 sheets mapped to the original Budget and Luxury lasagne meals (information that would have been lost in a traditional flat shopping list).

Consider now an example demonstrating how the mechanism deals with the user deciding to cancel an order that has ingredients overlapping with other recipes. The vendor system structural information tells the vendor system which items to remove. Concretely, suppose the user indicates via the UI that rather than 3 instances of “Budget Lasagne for 2”, they only wish to purchase 1 instance. Continuing our example from above, the vendor systems transform the data as shown in Table 3.

TABLE 3
User cancelled 2 instances of Budget lasagne,
leaving one remaining instance

| Abstract Shopping List | Instantiated List | |
|---|---|---|
| Hierarchy | Hierarchy | Flat Shopping List |
| 1 × Lasagne | 1 × Lasagne | 200 g fatty ground beef |
| (scaled to 2 portions) | (scaled to 2 portions) | 600 g lean ground beef |
| with Budget mapping | with Budget mapping | 8 sheets of lasagne |
| 1 × 200 g ground | 200 g fatty ground | dried pasta |
| beef | beef | |
| 1 × 2 sheets of | 2 sheets of | |
| lasagne dried | lasagne dried | |
| pasta | pasta | |
| 1 × Lasagne | 1 × Lasagne | |
| (scaled to 6 portions) | (scaled to 6 portions) | |
| with Luxury mapping | with Luxury mapping | |
| 1 × 600 g ground | 600 g lean ground | |
| beef | beef | |
| 1 × 6 sheets of | 6 sheets of | |
| lasagne dried | lasagne dried | |
| pasta | pasta | |

The “Fatty ground beef” order is trivially reduced from 600 g to 200 g, but the structural elements allow the vendor system to successfully reduce the order of dried lasagne sheets from 12 to 8, through the use of information how the dried lasagne products are allocated to the related abstract recipe orders being manipulated by the user.

Contrast this with the traditional “flat list” shopping cart, where the determination how much to reduce the order of an item used by several recipes must be done by the user; the user must for themselves work out how much the total changes by when one recipe is altered. This mechanism allows the operation to be undertaken automatically on behalf of the user, vastly simplifying the user-vendor system interaction for a more streamlined shopping experience.

A third sample operation demonstrates how the mechanism allows a user to customize how a recipe is instantiated, creating a new instantiation in the process. In this example, the user wants to change from using standard “lasagne dried pasta” to “Brand Y fresh egg lasagne”, customizing the “Luxury” instantiation. The mechanism implicitly creates a new instantiation to track and record this modified version.

The mechanism supplies a default instantiation name which the user is encouraged to customize, to be used as a “handle” when this or other users are browsing instantiations to use for a given recipe/list. The handle is not important to the current shopping cart instantiation, but it can (along with other classification methods) help to organize the use of instantiations of a given recipe/list. The result of the user changing the item in the instantiation is shown in Table 4 below.

TABLE 4
User customizes Luxury instantiation to
use “Brand Y fresh egg pasta”

| Abstract Shopping List | Instantiated List | |
|---|---|---|
| Hierarchy | Hierarchy | Flat Shopping List |
| 1 × Lasagne | 1 × Lasagne | 200 g fatty ground beef |
| (scaled to 2 portions) | (scaled to 2 portions) | 600 g lean ground beef |
| with Budget mapping | with Budget mapping | 2 sheets of lasagne |
| 1 × 200 g ground | 200 g fatty ground | dried pasta |
| beef | beef | 6 sheets of Brand Y |
| 1 × 2 sheets of | 2 sheets of | fresh egg lasagne |
| lasagne dried | lasagne dried | |
| pasta | pasta | |
| 1 × Lasagne | 1 × Lasagne | |
| (scaled to 6 portions) | (scaled to 6 portions) | |
| with “Luxury with | with “Luxury with | |
| Brand Y fresh egg | Brand Y fresh egg | |
| lasagne” mapping | lasagne” mapping | |
| 1 × 600 g ground | 600 g lean ground | |
| beef | beef | |
| 1 × 6 sheets of | 6 sheets of Brand | |
| lasagne dried | Y fresh egg | |
| pasta | lasagne | |

The user can in the UI customize the item used to instantiate the “sheets of lasagne dried pasta” line item from the 6-portion version of the abstract recipe, while the instances of the Budget mapping of the abstract recipe remain unaffected. The mechanism determines on behalf of the user that only 2 sheets of “lasagne dried pasta” are now required for the Budget mapping, and 6 sheets of the “Brand Y fresh egg lasagne” is required for the modified Luxury recipe instance. The mechanism has relieved the user of any need to track the details (specifically, what numbers of ingredients are assigned to each recipe), and lets the user concentrate on “higher-level” decisions.

The mechanism for storing and manipulating lists/recipes provides a solution for another problem: A method for rescaling a recipe/list in the following ways:
Rescale the quantity produced (e.g. number of portions)
Rescale the units provided themselves, effecting a change to portion sizes (for example, making portion sizes smaller to suit a diet or child portions).
Recast the recipe in different units (e.g. US imperial, UK imperial or metric units).

The above is achieved simply by including within the vendor system mechanism a “view/transformation” layer to allow the user to choose display units or to rescale a list.

A mechanism to (at the time or order fulfilment) on discovery of unavailability of an item, perform substitution not just of an individual unavailable item, but to (if necessary) perform substitution of a collection of items constituting a coherent abstract hierarchical object (anything from an individual item, to an entire recipe or meal) with another object pre-selected by the user as a substitution preference will now be discussed.

For example, suppose the user intends to make a complex recipe, places an order for the recipe, and when fulfilling the order it is found that a particular critical ingredient is unavailable. Existing order fulfilment systems will typically to either drop the individual ingredient, or make a substitution of a similar item. However, from the user's perspective, if a critical ingredient is unavailable, it may well be better to drop all the items for the recipe or even meal, and substitute the items for another (possibly completely different) recipe or meal instead.

This mechanism can include a way for the user to specify the following:
Within a list/recipe, whether specific individual sub-lists or items are critical, and cause the entire list/recipe to be dropped if unavailable.
For a given list instantiation (consisting of sub-instantiations for sub-lists/items), what alternative sub-instantiations to use if the selected sub-instantiation cannot be fulfilled.

This additional information provided by the user to the instantiation mechanism allows the following sequence of events:
The vendor order fulfilment process informs the instantiation mechanism of the unavailability of an individual item.
The instantiation mechanism uses the substitution preference information to determine the corrective action to take by the order fulfilment system, in terms of dropping items from the order and adding new ones to effect substitution of an abstract object as directed by the user preferences.

A mechanism for the user to customize the order instantiation mechanism will now be discussed.

The order instantiation mechanism includes user-interface components to allow “tagging” of items, instantiations and/or recipes. The concept of tagging follows established social-networking conventions. However, the order instantiation mechanism can build on the basic tagging feature to achieve the following.
A mechanism for the user to configure automated substitution based on tags. The following are example user configurations.
   If a sub-instantiation/item has the tag X, automatically replace it with a sub-instantiation without the tag X, or flag if not possible.
   If a sub-instantiation/item has the tag Y, automatically replace it with a sub-instantiation with the tag Z, or flag if not possible.

The following more concrete examples give an indication of how the tagging mechanism may be used:
Ingredient and vendor tagging to allow filtering of results by preferences (healthy, nut free, sweet; arbitrary tagging allowed). Used to filter search results to improve user tailoring of new recipes automatically.
Tagging usable by automated substitutions (e.g. “always replace milk with soya milk” or “substitutes must have tag ‘nut-free’”).
Search filtering based on tags could be either strict (e.g. “only nut-free”) or more relaxed (e.g. “show recipes that are nut-free or that can be coerced to be nut-free by my mapping rules”).
Some tags may have special processing for legal reasons (e.g. “may contain nuts”); such tags may be editable only by users with sufficient authorization.

A mechanism for the user to influence the order instantiation mechanism so that certain groups of items are considered “equivalent” for the purpose of breaking an abstract item requirement into a selection of concrete items will now be described. How the user can inform the order instantiation mechanism of conditions it must fulfil when instantiating the abstract items will be described.

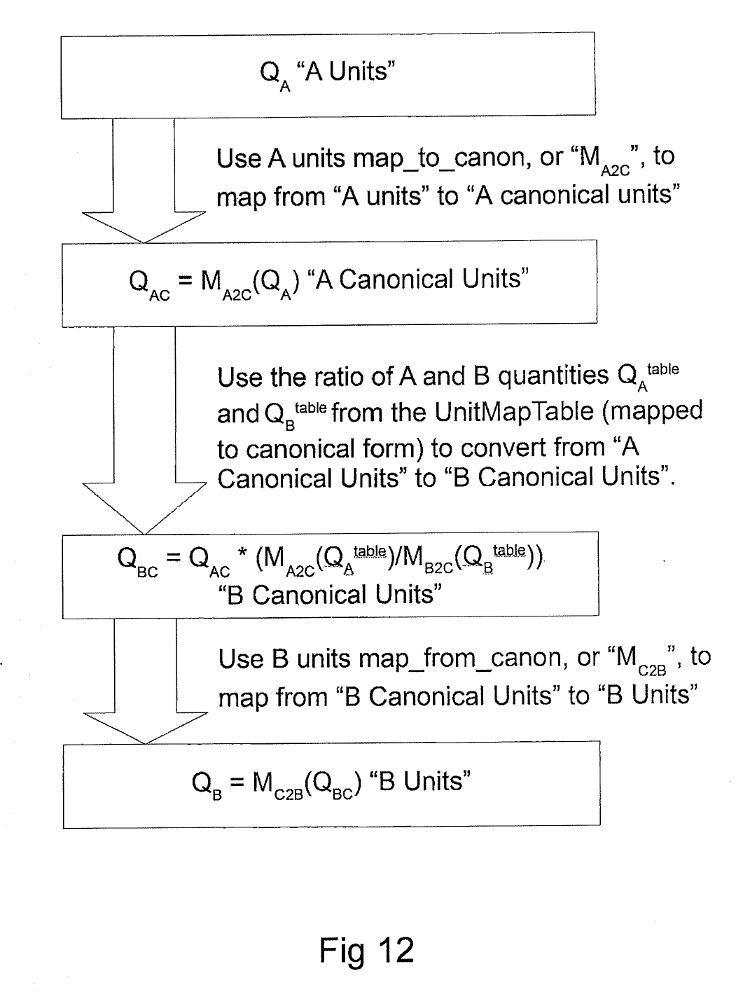

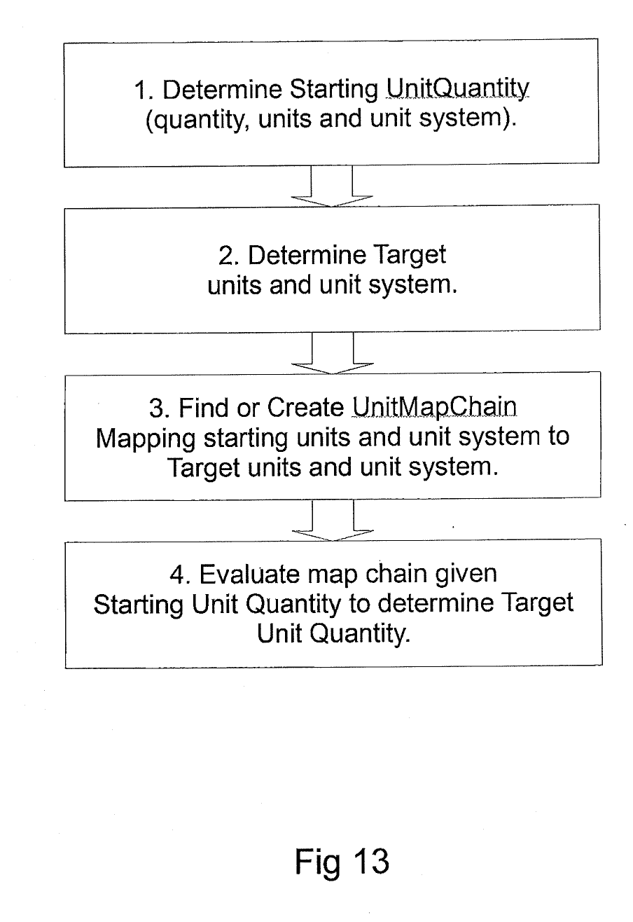

For example, the user and/or administrator can input information such as the following:
The following items should be considered interchangeable as an instantiation of “pasta sauce”, distinct only in the quantity they provide of the abstract item.
   “Brand Y pasta sauce 200 ml”
   “Brand Y pasta sauce 500 ml”
   “Brand Y pasta sauce 1 L”
   “Brand Y pasta sauce 2 L”
      In order to achieve this equivalence in the view of the instantiation mechanism, there must exist an instantiation path between pairs of items with an “equivalence-cost” below a certain threshold (the system has a default threshold that can overridden by user-preferences). A discussion of equivalence cost and its determination will be given below. The vendor would typically set up instantiations linking these items, but users can also create their own (for example, to link identical products sold by different vendors).
One recipe requires 650 ml of pasta sauce (this is inferred from the recipe used and the quantity of end-product required by the user; according to the quantity mapping mechanism discussed with reference to FIGS. 12 and 13) and will be used on a particular date (the UI can include a mechanism for this information to optionally be input by the user when adding a recipe to the shopping cart, or later specifying it for a list/item already in the cart, or inferred from a repeated shopping list including use date information, where the repeated list assumes use dates for sub-lists at the same offsets from the order date).
Another recipe requires 375 ml of pasta sauce and will be used 5 days later (see below for use date determination).
The pasta sauce items must be used within 3 days of opening.
Ingredients purchased should be within at least 95% of the required quantity (allowing a 5% error if it fits more naturally with quantities to purchase).
Do not use >=1 L pasta sauce containers.

The user input mechanism for the last condition causes the sub-instantiation for the “pasta sauce” line item to be tweaked by creation of a user-specific “instantiation condition” internal to the order instantiation mechanism. The condition is stored at a scope defaulting to “the most granular scope containing all instances of the source item for the instantiation”, but this scope is controllable by the user (it can store the condition in the instantiation of the line item, the recipe, or even as a permanent user-preference). The condition's storage scope affect whether it is applied to future recipes. The condition is enforced by the order instantiation mechanism to ensure the user restriction against containers that are too big is respected.

The mechanism uses linear programming techniques to find an optimized solution to minimise waste and error while keeping within the defined tolerance, supplying products in the established item equivalence class indicated by the user/administrator (apart from differing quantities) as required to achieve the solution.

Continuing the example, the order instantiation mechanism can determine that it should purchase 1×500 ml and 3×200 ml, to be used as follows:
1×500 ml+1×200 ml to satisfy the 650 ml requirement of the first recipe (plus 50 ml excess, the minimum error possible).
2×200 ml to satisfy the 375 ml requirement of the second recipe (plus 25 ml unavoidable excess).

Above, the requirements must be satisfied disjointedly, as a part-used item would not last from the use in the first recipe until the second recipe 5 days later. If the user then adjusts the second recipe so it is used only 2 days after the first (less than the 3-day opened lifetime configured above), the instantiation mechanism recognizes that it can make the order more efficient; it recalculates the instantiation as follows.
2×500 ml to satisfy the 650 ml requirement of the first and 375 ml of the second combined, for 1000 ml against a 1025 ml total requirement, for a 25 ml total deficit (2.5% error, within the 5% tolerance, and better than the 7.5% error from the instantiation in the first example).

Above the mechanism has determined that the part-item left from the first recipe can be re-used for the second recipe, as it is now within the 3-day “use by” period for the item. The 1 L pasta sauce container was not used because the last user condition prevented it; 2×500 ml items were instantiated instead.

If the user provides a planned use date, there is a mechanism to flag if product planned usage date is near/exceeds product ‘Use by’ date from delivery date.

How the object instantiation mechanism interacts with the user to achieve a multi-vendor shopping list will now be described, with the following features:
Vendor-agnostic shopping list management (manage what is purchased independently of where it is purchased).
   Includes a method for converting shopping list between vendor-neutral and vendor-specific forms (including many-many mappings between objects).
   Direct vendor-vendor mappings.
   User-definable mapping rules.
   Sharable mapping rules (users can publish a mapping for others to use)
Simultaneous management of multi-vendor shopping lists. The mechanism includes the following.
   A method for mapping product/list selections from one vendor to another in both automated and interactive manners.
   Mapping is possible as an alternative instantiation of the abstract object or directly as a vendor-item <=> vendor-item mapping.
   Mappings can be created automatically during user-interactions by recording interactive decisions. These can later be re-used if a similar operation is repeated at a future date.
   User-specific mappings will be used by default when present, falling back to other public mappings or interactive processing as required.

For example, consider a recipe consisting solely of 2 eggs (simplistic, but it serves as an example). Suppose it has 2 instantiations, one to instantiate it at one vendor as the product “6 Vendor A eggs”, and another instantiation at another vendor as “6 Vendor B eggs”. If the user starts with the instantiation at vendor A, then decides to move the recipe to vendor B, the instantiation mechanism can find and suggest the second instantiation. The user can accept this, or create a new instantiation at Vendor B. The instantiation mechanism will by default suggest the last instantiation the user used for this list/vendor combination, falling back to a “best fit” otherwise, using an unspecified algorithm possibly involving more user interaction.

If the user decides to move to using Vendor C for the recipe instead, if no instantiation exists yet for that recipe/vendor combination, the instantiation mechanism will first try to create one, by looking for suitable instantiations of each sub-list/item. If an instantiation exists mapping the recipe item “eggs” to a vendor C item which has previously been used by this user, this will be used by default, creating a new instantiation for this recipe in the process. Otherwise it will require user interaction to resolve, by interactively determining mappings for each recipe item (where existing public instantiations from other users may be suggested to the user).

Another possibility is that there may exist an instantiation that maps one specific vendor item to either an abstract item or to another vendor item. These can also be suggested as alternatives to the user by the instantiation mechanism. For example, there may be direct instantiation from “Vendor A eggs” to “Vendor C eggs”, or from “Vendor A eggs” to “free range eggs” and from there another instantiation to “Vendor C free range eggs”.

A shopping cart as represented within the order instantiation mechanism is not restricted in how it chooses to mix and match instantiations for different sub-lists/items, so a single shopping list (or even individual recipe) can have an instantiation that gets some items from one vendor and other items from another.

The mechanism for choosing the “best fit” instantiations to suggest to the user can include an option to minimize cost, taking each item from the vendor that offers the item cheapest.

The vendor-vendor mapping portion of the order instantiation mechanism operates as follows:
User indicates using the UI that a given item or list should be re-instantiated using an alternate vendor, for example, Vendor B (where Vendor A is in use by the current instantiation).
The order instantiation mechanism first searches for an existing instantiation of the selected item or sub-list that results in Vendor B items. If multiple such instantiations exist, it is prioritized according to the Instantiation Prioritization Algorithm described below.
The user is offered the instantiations in the order priority established above, possibly with the highest priority being selected by default.
If no suitable instantiations exist, or if the user declines to select any of the existing instantiations, then the order instantiation mechanism will attempt to construct a new instantiation. In the case of a sub-list, this is first achieved by recursively repeating this algorithm for each element in the sub-list, and collecting the results as a new instantiation of the sub-list as a whole. Below the mapping of an individual item is described.
In the case of an individual item, the mechanism now searches for the Vendor B items with the closest relation to the Vendor A item being mapped. It starts by looking for a direct instantiation of the Vendor A item as a Vendor B item.
Failing the above, it uses the “equivalence cost” tag-value ratings for instantiations leading to or from Vendor A to walk the directed graph of instantiations to find “least-cost” routes to a Vendor A item (traversing instantiations either direction in the process). The number of instantiations to traverse in the search will be governed by administrative limits to prevent consuming too many resources, and a “sparse tree” search can be used to search only the most promising routes. This is discussed more below.
Failing the above, the user can interactively select a Vendor B item to replace the corresponding Vendor A item.
Following completion of the process above, the result is recorded both as a direct instantiation between the Vendor A and Vendor B items, and as the new instantiation of each affected higher level abstract object that is implicitly created. This shortcuts the process when next this or another user attempts the same operation.

The Instantiation Prioritization Algorithm will now be described. It provides a mechanism to order a set of instantiations based on the following inputs:
Desired vendor (either from explicit user instruction or from current user preferences). The desired vendor can be unset meaning “desired vendor” has no influence on choice of instantiation (useful if a user typically shops at multiple vendors at once).
Instantiation most recently used by user—by default assume that the most recently used instantiation (filtered using the desired vendor above if set) should be re-used.
Fitness of instantiation relative to user-preferences (e.g. prefer instantiations with tag ‘X’). If user preferences have changed since the last use of the previously used instantiation above, and another instantiation is a better fit for the new user preferences, this can be flagged by the order instantiation mechanism to the user, so they can decide whether to choose the new instantiation to reflect the updated preferences.

Each instantiation can be assigned a tag-value pair used internally by the order instantiation mechanism that records the “strength of equivalence” of the item being instantiated and the instantiated result. The cost is 0 for something that is an identical object (differing only in Vendor or quantity, but the same actual manufacturer and item), with costs increasing as similarity decreases (e.g. “eggs” and “free range eggs” would take a small but non-zero equivalence cost, as they are very similar but not identical).

These equivalence costs turn the graph of instantiations into a weighted graph, and the order instantiation mechanism can calculate “least-cost” routes between points. Costs below a system or user-configurable threshold are considered equivalent items, used interchangeably by the instantiation mechanism as discussed below.

The “equivalence costs” assigned are tags like any other, in that a user can override the “default” value with a value of their own choosing, with the result that the instantiation mechanism results are affected. For example, many users may treat “free range eggs” and “organic eggs” as very similar, but other users may consider them not to be nearly as equivalent. By establishing their own values for the equivalence cost each user can improve the instantiation mechanisms results in relation to the user's own preferences.

Where a user has not explicitly specified a weight for a given instantiation, the algorithm uses a weight determined for them inferred from weights assigned by other users. One simple approach is to simply average other explicitly assigned costs from other users, but other more complex algorithms could be used instead (or even in combination, depending on server load), for example inferring a predicted cost assignment through correlating other cost assignments by this user and other users, either as an on-the-fly calculation, a pre-calculated result or through assignment of a user to a broad classification. The algorithm chosen is not important to the rest of the instantiation mechanism; it just needs to provide an inferred equivalence cost to each instantiation so the item “equivalence classes” above can be inferred for the user.

Separate from the instantiation process, multi-vendor shopping results in multiple fulfilment mechanisms (delivery or collection on a per-vendor basis). The user-interface has a mechanism whereby the selection of “delivery slots” can be coordinated, presenting the user with a view of available delivery slots using a variety of visual methods so the user can maximise the convenience (typically by selecting overlapping slots to minimize time the user must spend waiting at home for a delivery). Visual mechanisms include but are not limited to the following.
Onion-skin: Each vendor's delivery slots are displayed as a semi-transparent overlay on a calendar, with a colour and/or pattern representing each vendor. Vendors can be toggled on or off individually or all at once. Selecting a delivery slot selects it for all currently active vendors.
Intersection: Vendors can be toggled on or off individually or all at once. The calendar shows all delivery slots that are available to all currently selected vendors. Selecting a delivery slot selects it for all currently active vendors.

In the event that vendors use differently sized delivery slots (e.g. whole day vs 2 hour slots), this is communicated by showing both levels of granularity, and confirming the user understands (with optionally configurable suppression of the confirmation) before committing to the respective delivery slots.

A mechanism to communicate to and interact with the user regarding correspondences between sub-lists/meals/recipes and calendar dates will now be described. The mechanism combines display of a list of sub-lists/items as a legend for colour/pattern/icon-encoded calendar display (with options for weekly or full-month calendars). This provides the following interactions.
The user can see the date of a recipe's use by looking at a recipe's assigned colour/pattern/icon (hereafter referred to as “ID”) in the calendar display.
The user can see what recipes are scheduled for use on a given date by looking at the Ds contained in that calendar slot and correlating it to the legend display. Further information may be provided on mouse hover by “tool tips”, or by short-form text descriptions if space allocated to the calendar display allows it (in which case a legend may not necessarily be displayed).
The user can (re)assign the date a given recipe is to be used by dragging the recipe from the legend display or from its current calendar location to a new calendar date slot.
The user can un-assign the date for a recipe by dragging it from the calendar back to the legend area, or to a UI drop zone designated for this purpose.
The user may optionally manipulate multiple items in the calendar/legend by using common UI paradigms like shift-selection or ctrl-selection, and then applying one of the above operations.
The dates provided from this interaction can be used to influence the bundling of common items into larger packaged units from the same item equivalence class, as discussed below.

When repeating a shopping list (or a subset of one), any recipes/sub-lists assigned a date in the original instantiation will also be assigned dates in the repeated list, at dates determined as follows:

```
New use date for recipe =
  (user specified repeat date, or current date if unspecified) +
  (use date from original order - use date of earliest repeated item)
```

This calculation is done once at the point the order is repeated, and thereafter may be manipulated normally using the above calendar controls. The “user specified repeat date” may be determined by dragging a recipe directly from one UI control (like a favourites list) into a calendar date. Embodiments of the invention provide an algorithm for generating new constraints for a repeated instantiation from old constraints. The above is an example of such an algorithm for one such constraint type (use date).

In this manner a user could do such things as maintain a library of “a week's meals”, complete with intended days for each meal, and then just drag each week into the calendar to schedule a month's shopping (perhaps mixing things up a bit on a per-week level to inject some variety, but avoiding lower-level detail).

This date information can also be used by the order instantiation mechanism to warn the user if a shopping list needs to be split across multiple deliveries, for example because the shelf life of some items like milk or fresh herbs is less than the elapsed time from the first used item to the intended date of use of the perishable item.

As discussed above, a customer may wish to place orders as one logical order that require multiple deliveries from the same vendor to fulfil (perhaps to ensure freshness of perishable items).

This is achieved by maintaining multiple sub-orders for the user/vendor combinations where a split is required. The user can choose to partition the single logical cart into deliveries themselves, or can request the order instantiation mechanism itself partition the order. The user can then refine the partitioning by dragging items between UI elements representing the separate deliveries. If the user then continues to edit the shopping cart (adding items or otherwise editing the cart contents), the order instantiation mechanism will either automatically (re)partition new/edited items, or leave them un-partitioned and prompt the user if they return to the “checkout” process.

The instantiation mechanism should by default partition orders automatically into multiple deliveries to ensure items do not perish between purchase and use if usage dates are provided, but user-preferences can override this default behaviour.

The order fulfilment process could include labelling that relates the item back to the abstract hierarchy elements and constraints that resulted in instantiation of the item in question. For example, 1 kilo of ground beef sourced from the butchers' might have a label indicating it satisfies the requirements of 400 g ground beef for lasagne for Monday and 400 g ground beef for Chilli con came on Wednesday.

This keeps the user informed of the original intention when ordering, and allows them to plan things like freezer packing so items intended to be used first are nearer the front. It may also be useful information during the order fulfilment process, for example in determining if an item will be used before its use-by date, or refining item selection (like a butcher selecting a cut of meat to satisfy an order can select a more appropriate cut if they know what the intended use is).

This can be especially important if an item must be substituted during order fulfilment, or if the user has planned item use a long time in advance, so recall of the intended use(s) may be an issue.

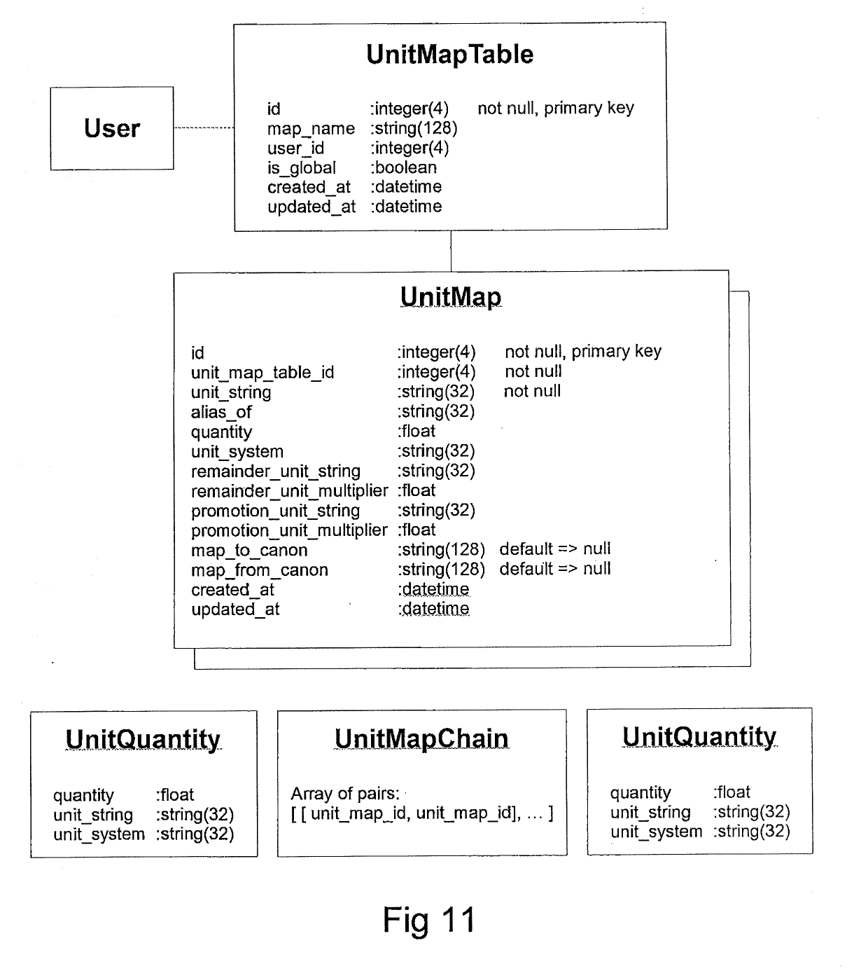

Unit and quantity mapping will now be described with reference to FIG. 11 which is a diagram illustrating the basic elements of Unit and Quantity mapping.

Some UnitMapTable examples (in row form) are shown below in table 5:

TABLE 5
Example UnitMapTable rows

| id | map_name | is_global | user_id |
|---|---|---|---|
| 47746671 | standard_weights | True | NULL |
| 419552473 | standard_volumes | True | NULL |
| 45678 | sifted_flour | False | 7 |
| 12345 | cake_produces | False | 7 |

The UnitMap objects (in a reduced row form; some fields have been omitted), are shown in table 6 below, in which the first 22 rows shown in bold belong to the table of the first row in table 5, the last 2 rows shown in italic belong to the table of the third row of table 5 and the remaining rows belong to the table of the second row of table 5.

TABLE 6
UnitMap example objects in row form

| id | unit_map_table_id | unit_string | alias_of | quantity | unit system |
|---|---|---|---|---|---|
| 8925060 | 47746671 | grams | g | NULL | NULL |
| 38209708 | 47746671 | kilogram | kg | NULL | NULL |
| 143124052 | 47746671 | kgs | kg | NULL | NULL |
| 151305484 | 47746671 | lbs | lb | NULL | NULL |
| 178488091 | 47746671 | ozs | oz | NULL | NULL |
| 223302309 | 47746671 | pounds | lb | NULL | NULL |
| 224230773 | 47746671 | gram | g | NULL | NULL |
| 246570098 | 47746671 | oz | NULL | 35.2739 | imperial_uk |
| 246570106 | 47746671 | oz | NULL | 35.2739 | imperial_us |
| 318347240 | 47746671 | lb | NULL | 2.20462 | imperial_us |
| 318347249 | 47746671 | lb | NULL | 2.20462 | imperial_uk |
| 323899090 | 47746671 | grammes | g | NULL | NULL |
| 392895280 | 47746671 | gs | g | NULL | NULL |
| 393165864 | 47746671 | kg | NULL | 1 | metric |
| 400024825 | 47746671 | kilograms | kg | NULL | NULL |
| 417862497 | 47746671 | kilogrammes | kg | NULL | NULL |
| 455076414 | 47746671 | kilogramme | kg | NULL | NULL |
| 535194523 | 47746671 | pound | lb | NULL | NULL |
| 581388903 | 47746671 | ounces | oz | NULL | NULL |
| 679438650 | 47746671 | g | NULL | 1000 | metric |
| 777429845 | 47746671 | ounce | oz | NULL | NULL |
| 822950513 | 47746671 | gramme | g | NULL | NULL |
| 25899372 | 419552473 | liters | L | NULL | NULL |
| 31301986 | 419552473 | fl oz | NULL | 33.814 | imperial_us |
| 31301994 | 419552473 | fl oz | NULL | 35.195 | imperial_uk |
| 41540187 | 419552473 | pints | pint | NULL | NULL |
| 50240735 | 419552473 | litres | L | NULL | NULL |
| 77725995 | 419552473 | teaspoon | tsp | NULL | NULL |
| 93746654 | 419552473 | gallon | NULL | 0.219969 | imperial_uk |
| 190628550 | 419552473 | pt | pint | NULL | NULL |
| 190831505 | 419552473 | mL | NULL | 1000 | metric |
| 190899147 | 419552473 | Ls | L | NULL | NULL |
| 225476412 | 419552473 | pint | NULL | 1.75975 | imperial_uk |
| 232636305 | 419552473 | fl. oz. | fl oz | NULL | NULL |
| 243785713 | 419552473 | L | NULL | 1 | metric |
| 262075105 | 419552473 | litre | L | NULL | NULL |
| 262954529 | 419552473 | liter | L | NULL | NULL |
| 340906143 | 419552473 | quart | NULL | 0.879876 | imperial_uk |
| 358566885 | 419552473 | fluid ounces | fl oz | NULL | NULL |
| 379229624 | 419552473 | mililitres | mL | NULL | NULL |
| 384008271 | 419552473 | tsp | NULL | 140.78 | imperial_uk |
| 384008279 | 419552473 | tsp | NULL | 135.256 | imperial_us |
| 441162241 | 419552473 | fl. oz | fl oz | NULL | NULL |
| 468130057 | 419552473 | tablespoon | tbsp | NULL | NULL |
| 489105989 | 419552473 | mililiters | mL | NULL | NULL |
| 582873845 | 419552473 | cups | cup | NULL | NULL |
| 583547121 | 419552473 | cps | cup | NULL | NULL |
| 583885362 | 419552473 | cup | NULL | 4.22675 | imperial_us |
| 616611087 | 419552473 | gal | gallon | NULL | NULL |
| 621640839 | 419552473 | mililiter | mL | NULL | NULL |
| 622520262 | 419552473 | mililitre | mL | NULL | NULL |
| 639369381 | 419552473 | fl oz | fl oz | NULL | NULL |
| 668473295 | 419552473 | mls | mL | NULL | NULL |
| 694573518 | 419552473 | pts | Pint | NULL | NULL |
| 727434545 | 419552473 | tbs | Tbsp | NULL | NULL |
| 755595799 | 419552473 | teaspoons | tsp | NULL | NULL |
| 797053119 | 419552473 | gals | gallon | NULL | NULL |
| 878557073 | 419552473 | fluid ounce | fl oz | NULL | NULL |
| 921201085 | 419552473 | tablespoons | Tbsp | NULL | NULL |
| 933373548 | 419552473 | tbsps | Tbsp | NULL | NULL |
| 962948752 | 419552473 | tsps | tsp | NULL | NULL |
| 1002510485 | 419552473 | tbsp | NULL | 67.628 | imperial_us |
| 1002510493 | 419552473 | tbsp | NULL | 70.3901 | imperial_uk |
| 1005850409 | 419552473 | gallons | gallon | NULL | NULL |
| 1065582790 | 419552473 | fl. oz | fl oz | NULL | NULL |
| 5 | 45678 | cup | NULL | 1 | imperial_us |
| 6 | 45678 | g | NULL | 140 | metric |

Above it can be seen that some rows do not provide numeric information, but instead have the alias_of field filled in. These rows allow aliases of a unit_string to be defined, with the unit_system inherited. For example, in the table above, it can be seen that “tablespoons” is an alias of “tbsp”, which in turn has two entries distinguished by unit_system (“imperial_us” and “imperial_uk”). This allows it to be inferred that in the imperial_uk system “70.3901 tablespoons==1 L” and in the imperial_us system “67.628 tablespoons==1 L”.

In FIG. 11 another pair of UnitMap attributes, “map_to_canon” and “map_from_canon” can be seen, which default to null. These provide references to functions that can be used to convert from the unit_string being described to an implied canonical unit that scales linearly with other units in the same UnitMapTable. If the unit already scales linearly, then it requires no mappings and takes the default value of null, and the mapping of units to canonical units is implied to be the identity mapping.

A concrete example helps illustrate the principle. Suppose a UnitMapTable “cake_produces”, id 12345, represents different attributes that can be used to describe the output of a cake recipe:

Table 7
UnitMap example for canonical mapping functions

| | unit_map_ | | map_from_ | map_to_ | | unit_ |
|---|---|---|---|---|---|---|
| id | table_id | unit_string | canon | canon | quantity | system |
| 7 | 12345 | cm | x\hat{ }2 | sqrt (x) | 10 | metric |
| 8 | 12345 | portions | NULL | NULL | 12 | NULL |
| 9 | 12345 | kgs | NULL | NULL | 0.5 | metric |

The exact semantics of the map_to_canon and map_from_canon fields is not important; it is just important that they define or imply a pair of functions which for consistency should be the inverse of each other.

In this example, it can be seen that to map from the cake tin radius in cm to a quantity that scales linearly with the number of portions or the weight of the cake, the radius in cm must be squared. From the above it can be seen that a 10 cm radius cake produces 12 portions. The mapping functions can thus be used to rescale this to get 8 portions as follows.
10 cm radius mapped to canonical using the map_to_canon function gives (10)̂2=100 cm canonical units.
The mapping table indicates these 100 cm canonical units are the same as 12 portions, with linear scaling between these units.
8 portions is therefore 8 portions*(100 cm canonical units/12 portions)=66.666 cm canonical units
Mapping back to cm radius using the map_from_canon function we have sqrt(66.666)=˜8 cm radius.

How many portions a 15 cm radius cake would serve can simply be determined as follows:
15 cm radius mapped to cm canonical units gives (15)̂2=225 cm canonical units.
From above we have that 100 cm canonical units will map linearly to 12 portions.
We therefore have that 15 cm radius=>225 cm canonical units maps to 225*(12/100)=27 portions.

This mechanism can be used to rescale lists that are defined in terms of attributes that scale non-linearly (as the cake radius::portions relationship in the example above).

It should be noted that each UnitMap row has a distinct implied canonical unit; if two unit map rows A and B had non-trivial mapping functions, you would map as shown in FIG. 12.

In FIG. 12 it can be seen that the process for using a unit map with arbitrary mapping functions to map between units A and B. In the event that all canonical mapping functions M are the Identity map (as implied by the map_to_canon and map_from_canon attributes for the row in the UnitMap table being null), the above process reduces to a simple linear mapping with ratios determined by the UnitMap quantities, Q_{B}=Q_{A}(Q_{B}^{table}/Q_{A}^{table}).

UnitMapChain objects require some explanation. A UnitMapChain is an ordered list of ordered pairs of UnitMap IDs (the first column in Table 6). For example, a UnitMapChain mapping litres of sifted flour to kg could be represented as follows:

| | |
|---|---|
| [ [243785713, 583885362] , | # Map L (metric) to cup (US) using |
| | # standard_ volumes UnitMapTable |
| [5, 6] , | # Map cup (US) to g (metric) using |
| | # sifted_flour UnitMapTable |
| [679438650, 393165864] ] | # Map g (metric) to kg (metric) using |
| | # standard_weights UnitMapTable |

In order for the UnitMapChain to be valid, the unit_string and unit_system must match for the UnitMap at the end of each pair and the UnitMap at the start of the following pair. In the example above, 583885362 and 5 must have matching units, and 6 and 679438650 must similarly agree. This ensures that the map chain makes sense as “Unit A=>Unit B, Unit B=>Unit C, . . . ”, using transitivity to effectively create a mapping “Unit A=>Unit C”, or from “L(metric)=>kg(metric)” in the example above, valid in the context of sifted flour.

FIG. 13 shows how the Unit Quantity mapping process works. Steps 1 and 2 above are generally implied by the context of the problem to which Unit Quantity mapping is being applied. For example, a list specifies one set of units as the required starting UnitQuantity, but the corresponding purchasable item is provided in different units. Continuing our example above, if a recipe/list specified 0.5 litre of sifted flour, but the flour is only purchasable as 1 kg bags, this supplies the Starting UnitQuantity of “0.5 L(metric)” and Target units of “kg(metric)”. Step 3 is a procedure in itself covered in more detail below. The end result of it is a UnitMapChain as in the example above.

Step 4 (map chain evaluation) is a simple series of operations where the Starting UnitQuantity is input, and transformed according to the sequence of UnitMapTable transitions until a quantity in the Target units is output. In this example, all the UnitMapTable relationships are linear scaled quantities; conversion is simply multiplying the input quantity by the ratio of UnitMap quantities from the selected rows of the UnitMap table:

0.5 L sifted flour * (4.22675 cup/1 L) * (140 g/l cup) * (1 kg/1000 g)
= 0.296 kg sifted flour

The UnitMapTable relationships could be more complex. It is only required that each UnitMap provide some invertible function to map between the specified unit and some canonical unit, then any two units in the table may be mapped by composing the relevant functions. This example is limited to linear mapping functions for simplicity, but any invertible unit mapping function could be allowed.

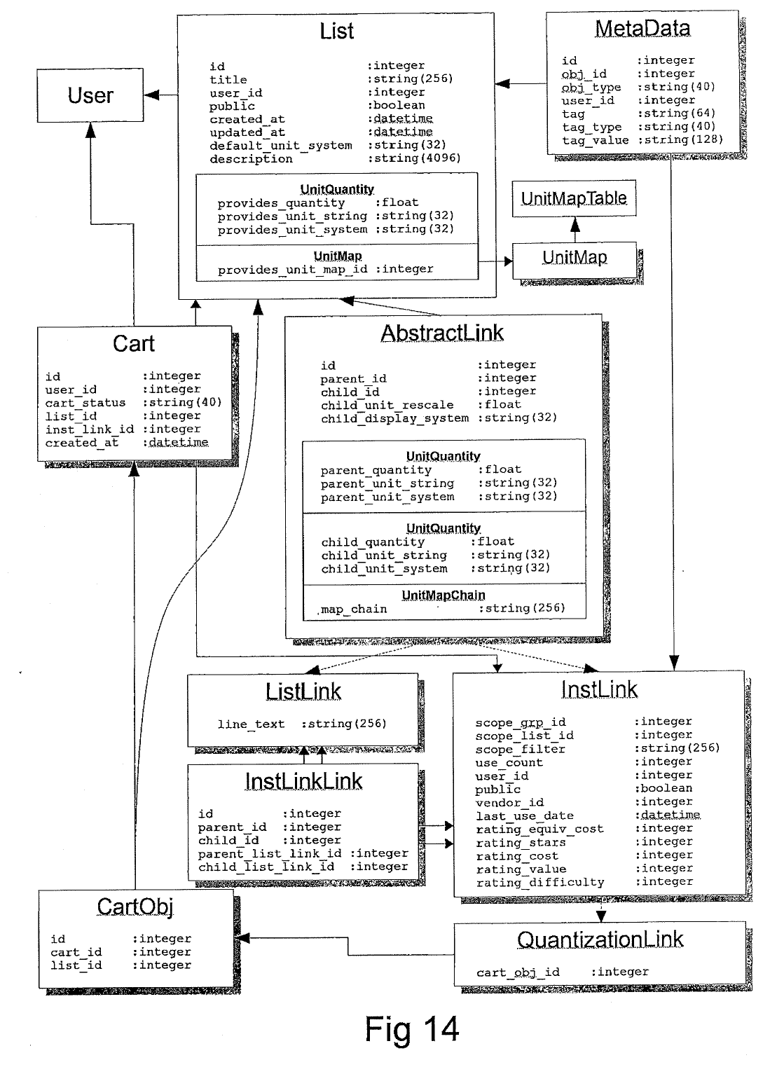

FIG. 14 shows the relations between various data structures, including both an Object-Oriented class inheritance point of view and interrelations between different structures.

In FIG. 14 a number of important relationships are illustrated. The “List” structure is of central importance, and the “ListLink” and “InstLink” structures are specializations of the “AbstractLink” type (with “QuantizationLink” further specializing InstLink).

The ListLink (and InstLink) data structures encapsulate a “weighted reference” from one List data structure, referred to as the “parent” to a “child” List. The *Link map_chain attribute describes how the UnitQuantity in parent units relates to the UnitQuantity in child units.

The ListLink objects encode how a List Composite Object (the parent) is made up from constituent Component Objects (the set of all objects that have the given parent). An individual Component Object may be the “child” referenced by many different composite objects; this reflects how the component objects are the individual parts that make up a number of different possible modular constructs.

The ListLink structures with a matching parent together describe the decomposition of the parent List Composite Object into the child Component Objects.

The MetaData data structure has a polymorphic reference to another data structure (of any type, including but not limited to List, InstLink, GroupQuantizationTabel or GroupQuantization), encoded in the obj_id and obj_type attributes. For example, the <obj_id 1001, obj_type “List”> pair refers to the List object with id attribute 1001. The MetaData user_id, tag and value fields allow for arbitrary global or per-user (depending on whether user_id is NULL or not) meta-data (the tag, typed-value pair) to be associated with a List or Inst object.

Examples of meta-data include a List's author name or picture (global information) or a star-rating (which could be global, like an aggregated rating from all users that rated the given List, or user-specific, like a specific rating given by the associated user). The MetaData may be used purely for presentation of List or InstLink information, or it may be used as an input into algorithms for choosing or creating List objects to represent a List object.

The “List” type contains other complex types, the “provides” UnitQuantity, and the “provides_unit_map” that optionally references a row in a UnitMapTable that may be used to convert the “provides” UnitQuantity into other unit types using the mechanisms described below. The values of these fields describe the quantity of the composite object produced when the sub-components of the “List” component objects are combined.

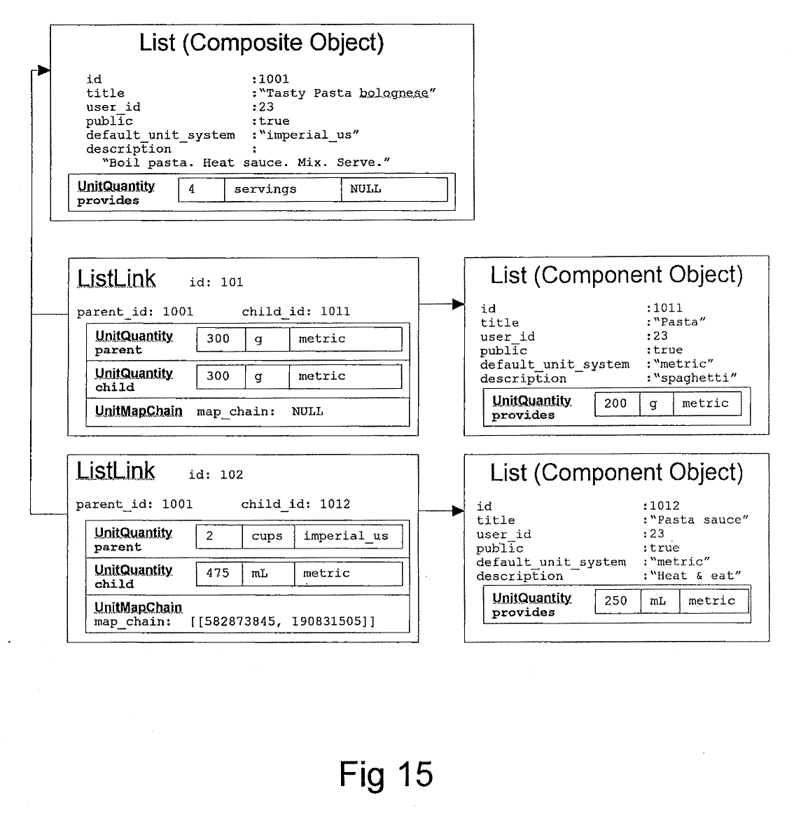

FIG. 15 illustrates an example of how a “List” Composite Object is associated via “ListLink” data structures with the child Component Objects that comprise the Composite Object. “InstLink” and “InstLinkLink” data structures have an analogous relationship. The way UnitQuantity attributes quantity, unit_string and unit_system are represented has been abbreviated to allow a more compact, readable representation. The ListLink “child” units are required by construction to match the “provides” units of the referenced child List. In fact, the “child” UnitQuantity is implied by the combination of the “parent” UnitQuantity and the UnitMapChain, and is listed as a “derived attribute” only for convenience.

Each ListLink object has two references, one “parent” reference to a List in the role of a Composite Object, and one “child” reference to a List in the role of a Component Object. A List object can occupy each role simultaneously with respect to different ListLink objects. For example, the “Pasta” object above (id 1012) is the Component Object relative to the “Tasty Pasta Bolognese” (id 1001)'s Composite Object. However, this “Pasta” List may also be considered a Composite Object itself, relative to Component Objects representing “flour” and “egg” (not shown). In this way a “decomposition hierarchy” can be formed by repeating the decomposition relation.

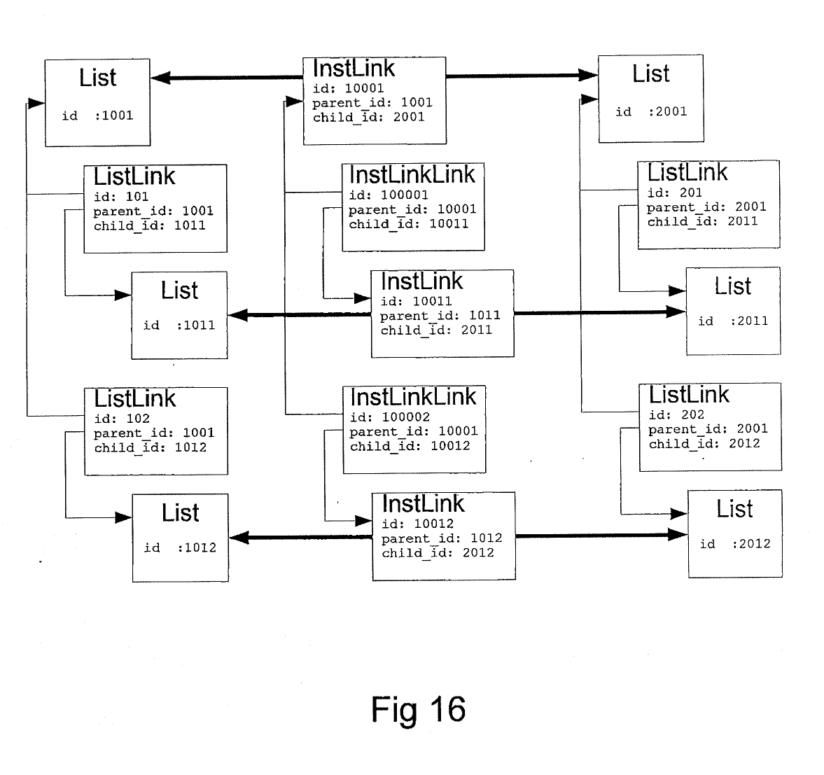

The InstLink data structure, while sharing some properties with the ListLink type (via the shared AbstractLink type) serves a different purpose. An individual InstLink data structure stands on its own independent of other InstLink data structures sharing the same parent List. Each InstLink represents the “is a” relationship between one List data structure and another. FIG. 16 illustrates the relation between List and InstLink structures.

There is no guarantee or requirement that the child list hierarchy be equivalent or even similar to the parent list hierarchy. However, when there is a relationship between the hierarchies, this can be represented, by additional InstLink data structures and InstLinkLink structures to encode the hierarchical information. It is required that there either be no InstLinkLink children of an InstLink node, or there must be a 1-1 mapping between the “parent” List/ListLink hierarchy and the “child” hierarchy (as shown in FIG. 16).

The InstLink object id 10001 above defines a link from the parent List id 1001 to the child List id 2001. This link is called an “Instantiation”, and List id 2001 is said to be “an instantiation” of List id 1001, via the InstLink id 10001. When discussing instantiation, the “via <InstLink>” will often not be mentioned. Above it can similarly be seen that List id 2011 is an instantiation of List id 1011, and List id 2012 is an instantiation of List id 1012.

The value in having the additional InstLinkLink structures is that after choosing the instantiation id 10001 to instantiate List id 1001 as List id 2001, it can be recorded that List id 1011 has been instantiated as List id 2011 (via InstLink id 10011), so if List id 1011 later needs to be instantiated (outside of the context of the Composite Object List id 1001), information exists to suggest that List id 2011 is a suitable choice.

The key to the InstLink data structure is that it represents a replacement or substitution operation in its entirety (unlike a ListLink data structure, which describes one part of a composition operation). The various rating_* attributes describe properties of the “replacing” (child) object relative to that of the object being replaced (the parent). The rating_* attributes are logically just additional MetaData associated with the InstLink object, stored in the object itself for convenience.

For example, let List A represent an abstract recipe (a Composite Object where the child Component Objects are not vendor products, but abstracts like “eggs” and “pasta”). Let List A′ represent a recipe for the same dish, but in more detail (comprising specific vendor products as Component Objects, like “6 Brand X eggs from Vendor Y”). An InstLink data structure could link List A to List A′, providing the following:
“Inst_name” is a short summary of List A′, distinguishing List A′ among other ways of “instantiating” List A, or mapping it to a specific set of vendor products. For example, “Cheap Vendor Y eggs and pasta”. This is not used by the instantiation algorithm, but is presented in the user interface as a distinguishing characteristic of an instantiation.
“user_id” may be NULL or a specific user_id. If non-NULL, other attributes are specific to this user. If NULL, this presents global “aggregated” view for all users, where the method of aggregations depends on the attribute (it may be a total or average of per-user values, or some other algorithm may be used to provide a global value from per-user values).
“use_count” tracks how many times List A has been instantiated using List A′ (globally or per-user, depending on user_id).
“public” is a flag that allows a user to determine whether their mapping between List A and List A′ may be used to assist other users making similar decisions.
“vendor_id” is a property inherited from the leaf entries of the child list (List A′). It allows users browsing instantiations of List A to easily filter results by target vendor.
“last_use_date” is the last time an instantiation was used.
“rating_equiv_cost” is a sliding scale used to describe how similar List A and List A′ are. This is discussed further below.
Other “rating_*” attributes allow users to rate List A′ as an instantiation of List A, in terms of overall rating (“stars”), cost, value and difficulty (to name a few). Arbitrary additional metrics could be added here.

When searching for ways to instantiate a parent List, the above properties can help the user select an appropriate InstLink (and hence child List) to suit their needs. A given List may have many instantiations (many InstLink objects specifying the given List as the parent). Two child List instantiations of the same parent List will typically differ by at least one ListLink child data structure (but are not required to), and probably by one or more MetaData tag-value pairs (though again, differences are not required).

Consider the following example. A List can be thought of as a pattern or a design for a Composite Object, made up of various sub-components. Different concrete instantiations of the same design may vary in numerous ways, like the quality of the components used. The end result is an object fulfilling the same general function (it “provides” the same quantity of some unit of measure), but it will have more detailed properties (for example cost, or mean time between failures) that may make it more or better suited for use in a particular context than a different instantiation of the same List.

The breakdown of a parent “List” Composite Object into child “List” Component Objects may be arbitrarily similar or dissimilar to the breakdown of the corresponding parent “List” Composite Object. Typically a strong degree of similarity is expected between the respective component hierarchies, but it is not strictly required. For example, one instantiation “List A” of the “Tasty Pasta Bolognese” List from our previous examples may follow the same breakdown into composite “Pasta” and “Pasta Sauce” List sub-objects (a completely parallel hierarchy to the List), while another instantiation “List B” may take another approach, providing instead a simple “Spaghetti Bolognese Ready-Meal” as a singular unit satisfying the high-level requirements of the entire List object. Both “List A” and “List B” are instances of the original List object (linked by an InstLink object), but have varying properties like cost, time to prepare, quality, etc. Continuing the example, there could be a third instantiation “List C” that actually substitutes the entire meal for a completely different one (say, a meat loaf). Depending on the user, that may be a perfectly acceptable implementation of the original parent List (and in fact forms the basis of substitution logic discussed later).

User-specific InstLink objects allow individual users to record evaluations of various instantiations (in multiple dimensions, including but not limited to cost, value, effort, and equivalence), so that the instantiation algorithm (discussed below) can attempt to make what the user would consider “good” selections automatically.

The Composite Object, ListLink objects and child Component Objects shown in FIG. 15 when combined define an “Implicit UnitMapTable” for each ListLink object. This implicit table allows a quantity of the Composite Object “provides” units to be mapped to quantities of the corresponding Component Object's “provides” units. The procedure is as follows:
For each ListLink object, the Implicit UnitMapTable has the following rows:
   Parent Composite Object “provides” UnitQuantity, with canonical map functions inherited from the UnitMap referred to by the parent “provides_unit_map_id” attribute. In our example this is not specified by the parent (provides_unit_map_id takes the default NULL value), so the canonical mappings are the default Identity mappings.
   ListLink parent UnitQuantity, with canonical map functions inherited from the first UnitMap referenced by the List Link's UnitMapChain attribute. If the UnitMapChain is the default NULL, then the canonical map functions are the default NULL/Identity map functions.

For the example shown in FIG. 15, the following are two implied unit map tables (canonical map functions and alias_of fields are omitted as they are all NULL in this example):

TABLE 8
Implied UnitMapTable for ListLink 101.

| Id | unit_map_table_id | unit_string | quantity | unit_system |
|---|---|---|---|---|
| <imp-table- | <implied-table-1> | portions | 4 | NULL |
| 1-unit-1> | | | | |
| <imp-table- | <implied-table-1> | g | 300 | metric |
| 1-unit-2> | | | | |

TABLE 9
Implied UnitMapTable for ListLink 102.

| Id | unit_map_table_id | unit_string | quantity | unit_system |
|---|---|---|---|---|
| <imp-table- | <implied-table-2> | portions | 4 | NULL |
| 2-unit-1> | | | | |
| <imp-table- | <implied-table-2> | cups | 2 | imperial_us |
| 2-unit-2> | | | | |

These Implied UnitMapTables may then be combined with the UnitMapChain attributes on the respective ListLink objects to create a UnitMapChain that can be evaluated to determine, given an arbitrary rescaling of the Composite Object UnitQuantity (in our example, number of portions), how much of the corresponding Component Object (in its “provides” Units) is required.

Continuing the example, suppose that “6 portions” of “Tasty Pasta Bolognese” (list id 1001) is required. Following the procedure outlined below for each of Table 8 and Table 9 respectively yields the following.
6 portions*(300 g/4 portions)=450 g of “Pasta” is required. ListLink id 101 has a UnitMapChain of NULL, so this is in the required units for the Component Object “Pasta”.
6 portions*(2 cups/4 portions)=3 cups of “Pasta sauce” is required. ListLink id 102 has a UnitMapChain of [[582873845, 190831505]], referencing rows (for “cups”, an alias of “cup”, and “mL”) from the UnitMaps listed below. Evaluating the UnitMapChain, we have that 3 cups*(1000 mL/4.22675 cups)=˜710 mL, which is now correctly in the same units as the Component Object “Pasta Sauce” provides.

In the case where there are multiple layers of composition, this procedure may be repeated for each layer to determine the required quantities of the “leaf” objects in the composition hierarchy.

List Component Objects may be grouped through use of the InstLink data structure. This allows a collection of Lists to be collected together and instantiated as a single List object. The InstLink data structure includes fields scope_list_id and scope_grp_id identifying the list that the “Group” belongs to, and the identifier of the “Group” within that scoping list.

The InstLink further contains a scope_filter attribute used to filter the scope of the grouping operation, to include only paths from the scoping list to the “parent” list being grouped that match the filter. Filters follow the ABNF

scope_filter = NULL | *scope_filter_elt
scope_filter_elt = empty_match | “:” link_id “:” | wildcard
empty_match = “”
link_id = “L” 1*digits | “I” 1*digits | “IL” 1*digits |
“ILL” 1*digits
wildcard = “*”
digits = 0-9

Some example scope filters, matching any instance of parent_id list under scope_list_id, subject to additional conditions.
NULL or “ ” or “*” matches any instance of parent_id list under scope_list_id
“:I3:” matches if there is only an instance of InstLink id 3 between list_scope_id and parent_id.
“:L6:” matches if there is only an instance of ListLink id 6 between list_scope_id and parent_id.
“:L6::I3:” matches if there is only an instance of ListLink id 6 followed immediately by InstLink id 3 between list_scope_id and parent_id.
“*:I3:” matches if there is any number of nodes followed by only an instance of InstLink id 3 between list_scope_id and parent_id.
“*:I3:*” matches if there is an instance of InstLink id 3 anywhere between list_scope_id and parent_id.
“*:L6:*:I3:*” matches if there is an instance of ListLink id 6 followed at any point by InstLink id 3 between list_scope_id and parent_id, with any combination of other intervening nodes.

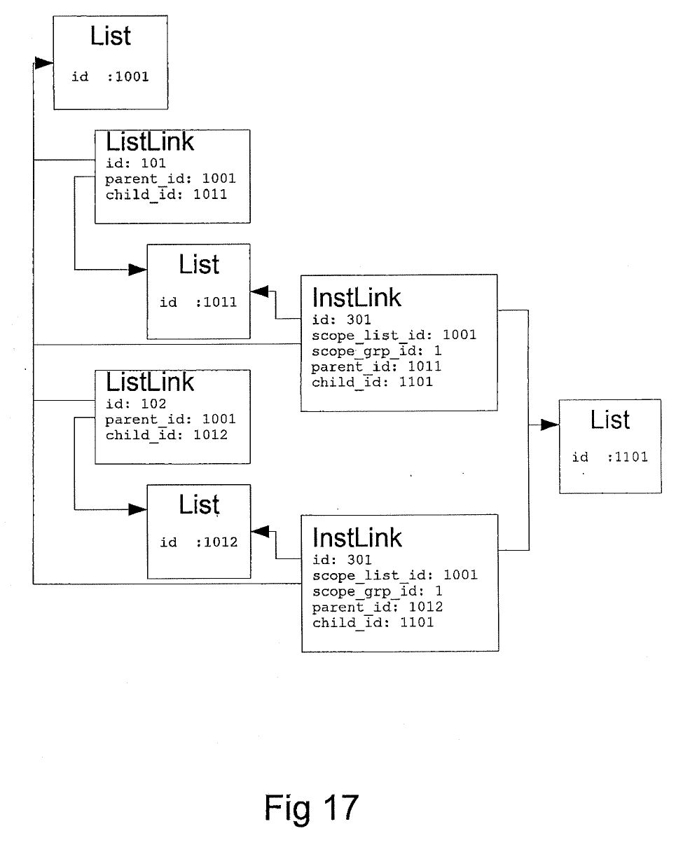

The scope filter provides enough flexibility so that either a single instance of a list, all instances of a list or all instances of a list matching a particular pattern of ancestry can be grouped together. An example grouping is shown in FIG. 17.

The grouping is performed at the scope of the referenced “scope_list_id”. All instances of the child lists below that scope have their requirements combined according to the mapping rules in the GroupLink map_chain attributes. The common child List (id 1101 in the example above) can then be instantiated to satisfy the combined requirements of the grouped parents Lists (ids 1011 and 1012 in the example).

Considering now the process of the quantization of the objects, there are a couple of ways in which instantiation results may need to be quantized:
Leaf nodes in the instantiation hierarchy may need to be quantized to match the quantities in which they can be purchased. For example, a particular type of rivet may only be purchasable in bags of 100.
Arbitrary nodes in the instantiation hierarchy may need to be quantized for other reasons.
A user may need to fit the amount of cake ingredients purchased to match or exceed an integral number of cakes of a particular size, with the size determined by the dimensions of the specific user's cake tin (making half a cake would probably burn if the same cake tin was used, as volume/surface area ratios would be impacted).
Another example where a production run of some sort of unit fabrication may have a minimum number of units that can be produced (say 5000), and the number produced can only be controlled at the granularity of 1000 units.

Further, while an individual item may have particular quantization characteristics, there may exist other items of varying degrees of similarity with different quantization characteristics.
A particular brand of pasta sauce may come in 200 mL, 500 mL and 1 L containers.
A different brand may come in 250 mL, 400 mL and 800 mL containers.

This example is illustrated below, where we assume that there exists the following sets of InstLink data structures.
For each pair of sauces of the same brand, there is an InstLink structure linking them, with rating_equiv_cost value of 0 (completely equivalent).
For each pairing of sauce items of differing brand, there is an InstLink structure linking them with a non-zero rating_equiv_cost (for example, 20) indicating it is not a complete equivalence.

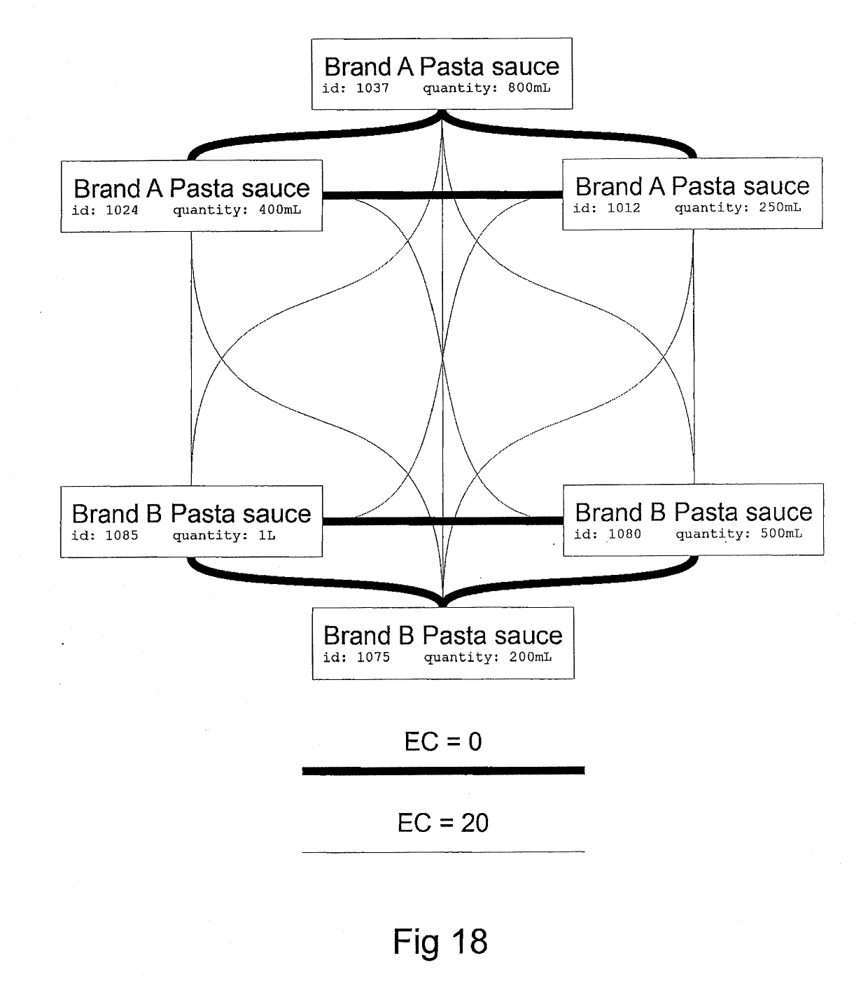

FIG. 18 illustrates the determination of InstLink equivalence costs for item quantization.

There is then an optimization problem to be solved, minimising a user-specific cost function with inputs including similarity of items, suitability for bundling together (if two sauces are needed on dates too far apart, one large container may spoil before it can be reused), cost, preference both for specific items or for particular quantities, etc.

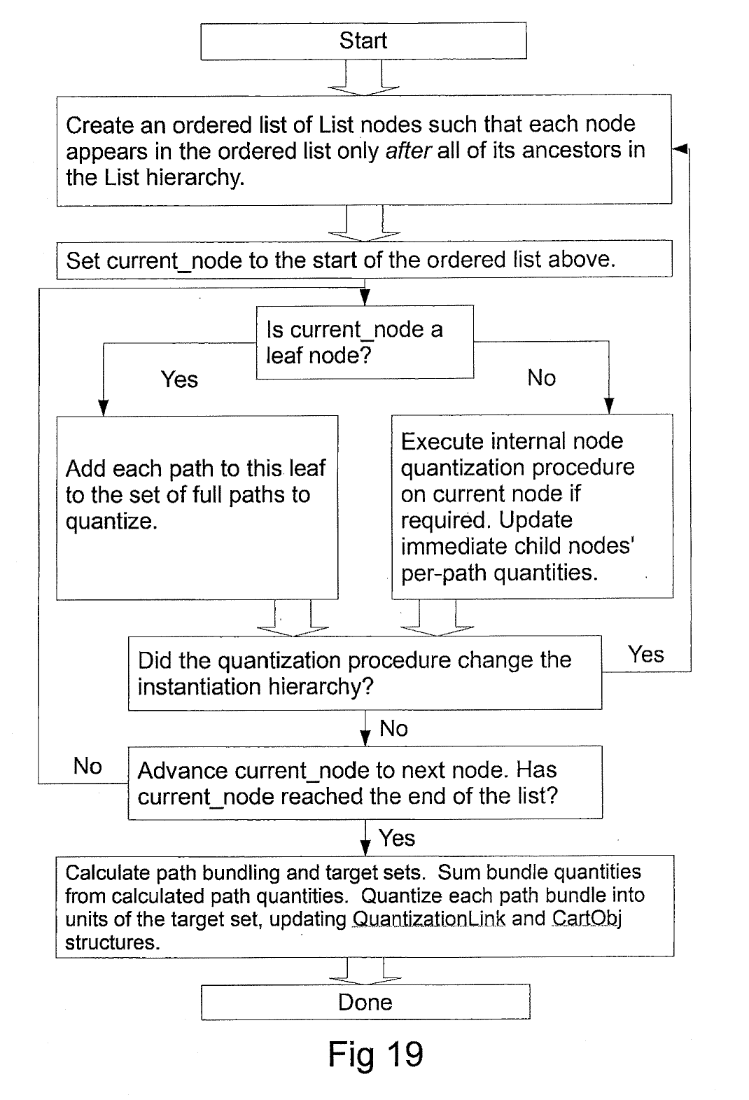

In FIG. 19 the procedure for traversing the hierarchy from the “top down” is illustrated, taking care that a Component Object may be referenced by multiple distinct Composite Objects. The ordering of the list of “List” nodes ensure that when processing a Component Object node, all its referring Composite Object nodes will already have been processed. As part of the process, a set of paths has been built to each List node.

The “per-path quantity” in the flow chart is the total required of a given Component Object from a given path of referring Composite Objects, after taking into account any quantization requirements of the Composite Object nodes. This is the quantity determined by following each path from the hierarchy root to the Component Object under consideration according to the UnitMap procedures discussed earlier, subject to the consideration that some intermediate nodes may have been quantized (see below).

The two sub-procedures in the flow chart are further explained below.
The “internal node quantization procedure” (or INQP) is effectively a rounding operation. The node will supply a function to map a presented quantity value to a rounded value. Note that the List object description in FIG. 14 has omitted this optional quantization function for brevity. The nature of the rounding function is not prescribed, but examples include rounding up to the nearest multiple of a quantity, or rounding to the nearest (An+B) for integral n and constants A and B. By default, internal nodes do not have quantization functions. Further to this, the INQP is performed once for each collection of paths that may be bundled together, and the contribution of each path to child links from the quantized internal List node is scaled according to the rounding result. The path bundling algorithm is discussed further later.
The “leaf quantization procedure” (or LQP) is more complex, and can be performed only after all paths have been evaluated to determine a quantity of the corresponding leaf List.
   First a “target set” of Lists is determined for each leaf List. This is the set of actual purchasable Lists that correspond to the leaf List. The procedure used is not prescribed, but an example would be to search for all Lists related to the leaf List by an InstLink with a low rating_equiv_cost value, indicating it is a close substitute.
   The path bundling procedure partitions the paths into bundles (sets of paths). This may be informed by user-input Group operations, user preferences or other MetaData. A very simple algorithm would be to simply bundle any paths that terminate at the same List, but much more complex algorithms are possible.
   Each bundle is quantized, resulting in a set of QuantizationLink (QL) and CartObj (CO) structures. Each CartObj represents a single purchasable item (referencing a List from the corresponding target set). Each QL maps from a portion (possibly all) of a path quantity to a portion (possibly all) of a CO.

Note that if no internal nodes require quantization, the quantization procedure reduces to “build a set of paths” followed by “execute LQP”.

Also note that the steps outlined in the LQP are not prescriptive; any mapping that takes the input hierarchy and generates a set of QL and CO objects is “valid” (though its usefulness obviously depends on it being a “good” algorithm, in terms of producing results that are helpful to the user).

The process of the instantiation will now be described in detail to explain the use of the data structures.

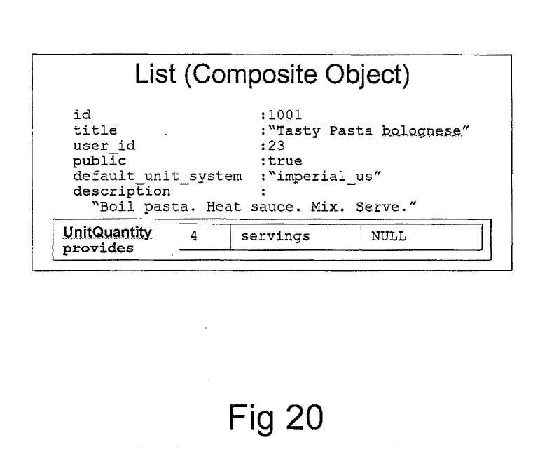

FIG. 20 illustrates a composite object which has an id 1001 a title “Tasty Pasta Bolognaise” a user id of 23, the composite object is public, the units to be used are Imperial and it has a description which relates to the recipe stating “boiled pasta. Heat sauce. Mix. Serve,”. The unit quantity provides for four servings.

Thus the list for the composite object is created as an empty list by the user to initiate the process.

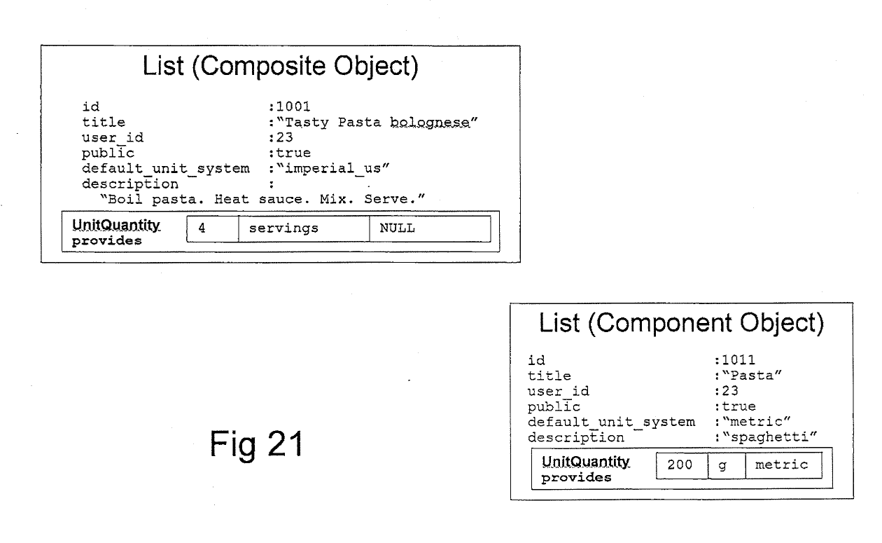

FIG. 21 illustrates the creation by the user of another empty list for a component object. This list has an id of 1011 and the title of “Pasta”. It has the same user id and is also public. The default unit for this component object is metric and as a description it has “Spaghetti”. The unit quantity provides for 200 grams in metric as the units of measurement.

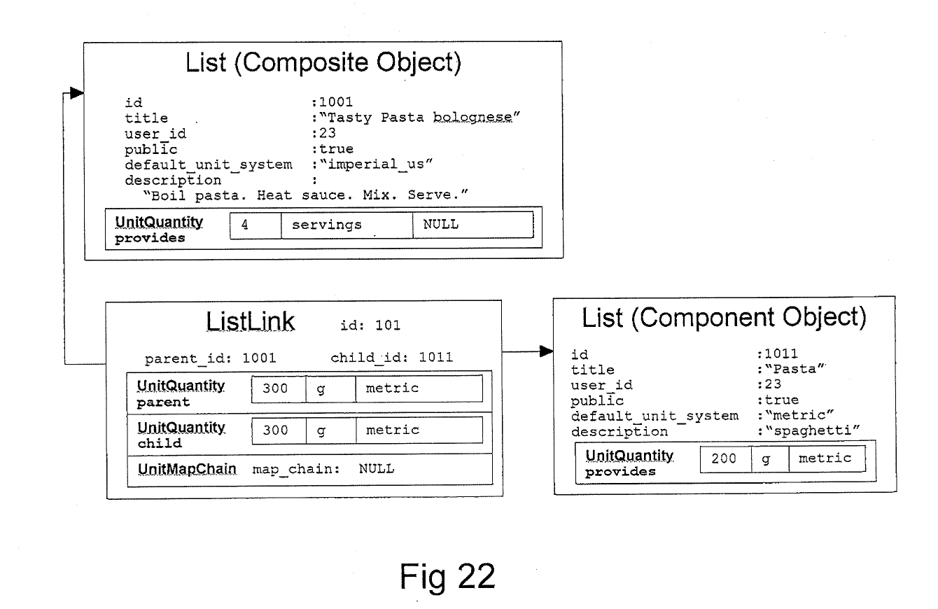

In FIG. 22 the user links the second list as a component of the first. This forms the ListLink with an id of 1001. The ListLink defines the parent and the child by their ids. Within the ListLink the unit quantity for the parent and the unit quantity for the child are defined. In this case, the recipe for the composite object requires 300 grams and hence there is no unit mapping required.

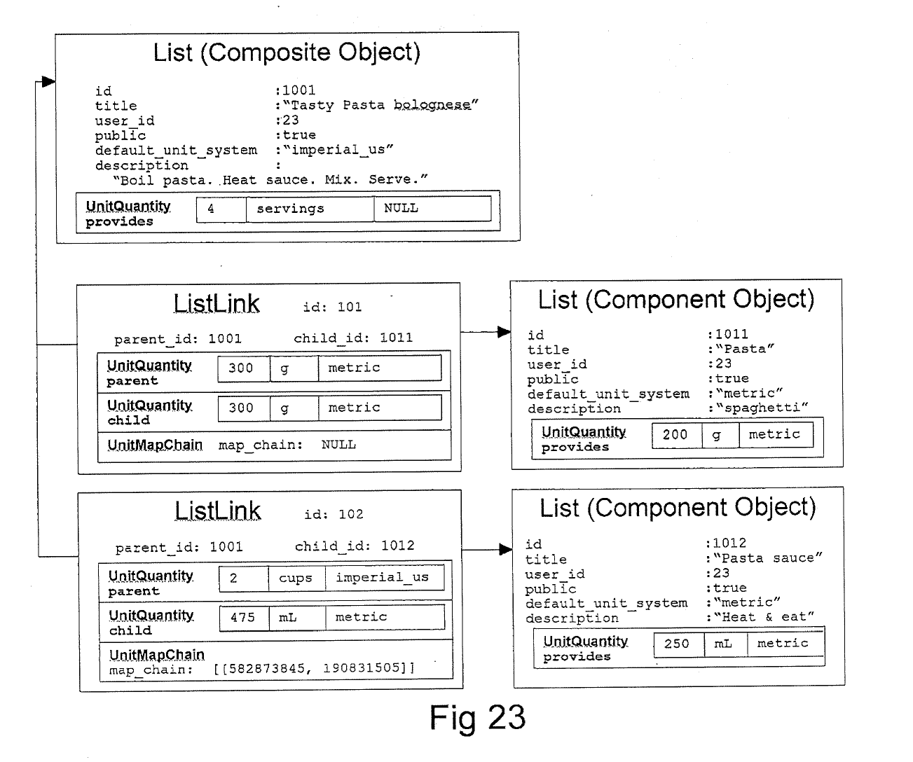

In FIG. 23 a user creates a second sub-component and links this with the composite object in the same way. This second component comprises a pasta sauce with an id of 1012. The default units are metric and the unit quantity for the component object is 250 mls. In the ListLink the parent id and the child id are identified. The unit quantity defined in the composite object is two cups and the unit of measurement is Imperial. This has been converted into a child quantity of 475 mls using the unit mapping defined in the ListLink.

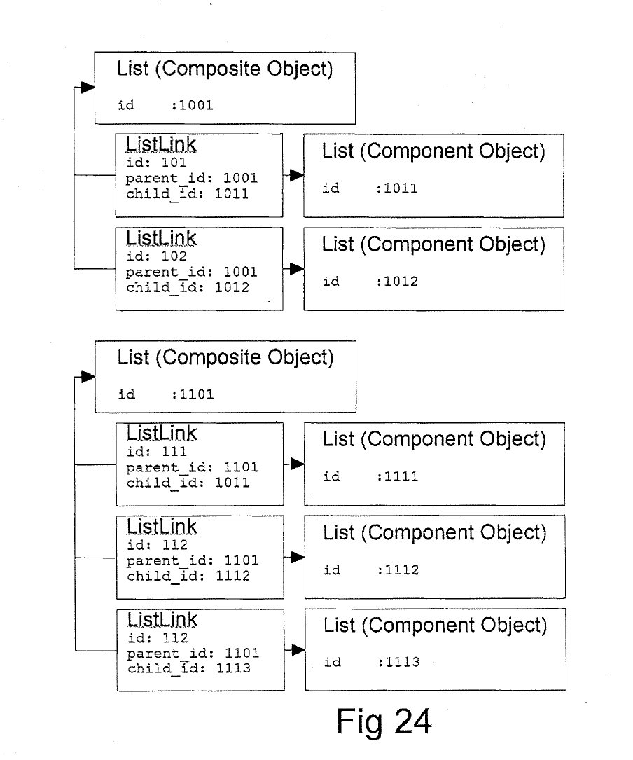

In FIG. 24 a user creates a second composite object with an id of 1101. This has three component objects with ids of 1111, 1112 and 1113. These are linked by respective ListLinks with ids 1111, 1112 and 1113.

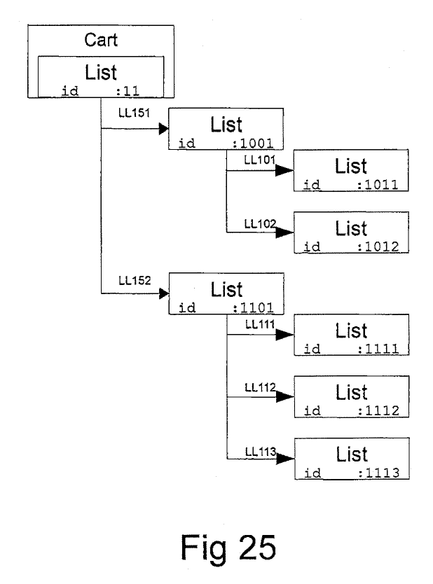

In FIG. 25 each of these composite objects which are simply now termed lists are added to the shopping cart. The shopping cart has a list id of 11 to define the instance of this shopping cart.

Then the user begins the checkout process. So far none of the new lists have InstLink mappings which maps them to concrete component objects so the user must create such mappings this first time by selecting components manually for each leaf node in this hierarchical structure.

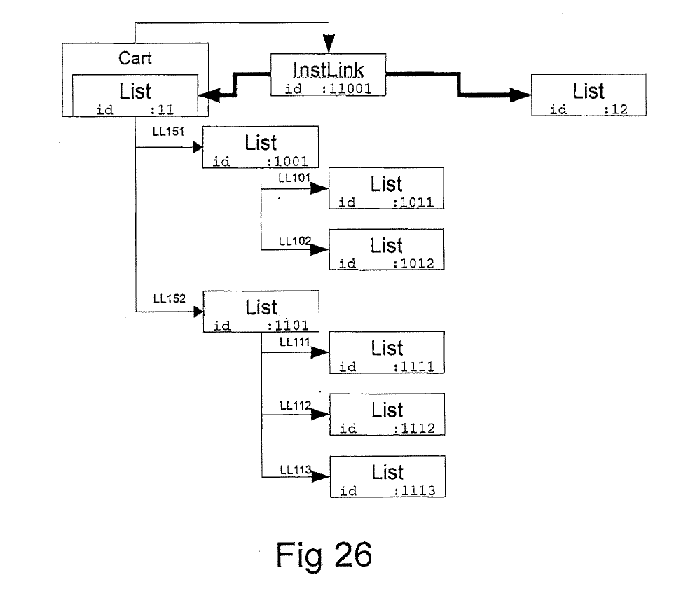

In FIG. 26 the starting of the check out process creates the InstLink id 11001 and the List id 12 (which is currently an empty container). The cart structure references the top level InstLink through its inst_link_id attribute. This is omitted in diagrams 28 to 49 to avoid clutter in the illustrations.

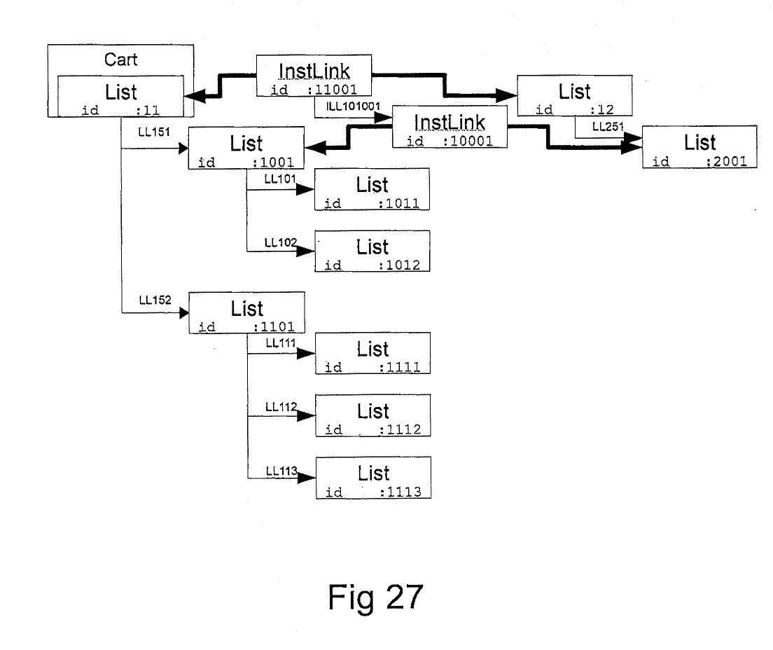

As illustrated in FIG. 27 the cart List id 11 is recursively instantiated, starting with List id 1001. Since no InstLink with this List as a parent exists yet, and this List is a composite object, and InstLink is created, InstLink id 10001 pointing to the newly created List id 2001. InstLinkLink id 101001 is also created implicitly and this is shown in line form only, as is ListLink id 251 linking List id 12 to List id 2001. The InstLinks map between lists and InstLinkLinks mirror the ListLinks. The InstLinkLink id 101001 allows a direct relationship between List id 2001 and List id 1001 to be observed, through InstLink id 1001. Without the InstLinklLink and the subsidiary InstLink structure a relationship between List id 2001 and id 1001 in the context of InstLink id 1001 could not be unambiguously inferred. Such a relationship does not always exist but it may. The process recourses again to List id 1011. This is not a composite object, so when no InstLink is found, one is not automatically created. Instead the user is prompted to provide the mapping from the List id 1011 to an existing component (or composite) object.

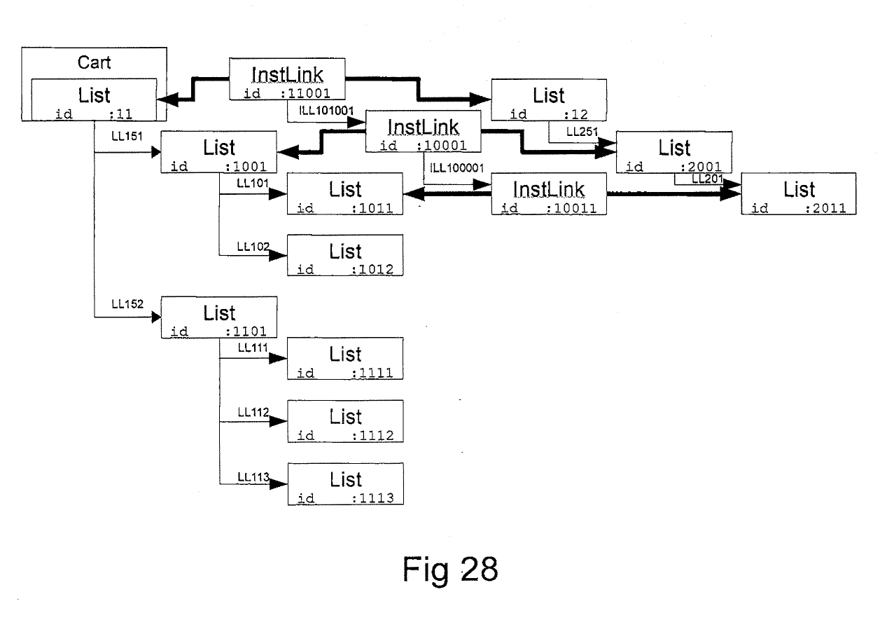

Referring now to FIG. 28, the user maps List id 1011 to the component object List id 2011. This creates InstLink id 10011, InstLinkLink id 100001 and ListLink id 201.

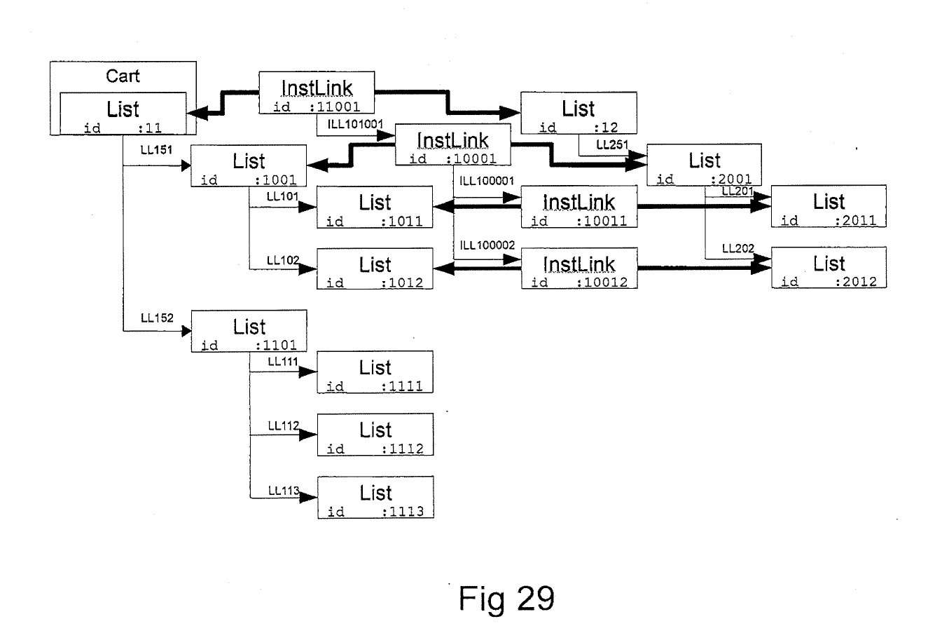

Referring now to FIG. 29, the user is similarly prompted for List id 1012, resulting in the links shown.

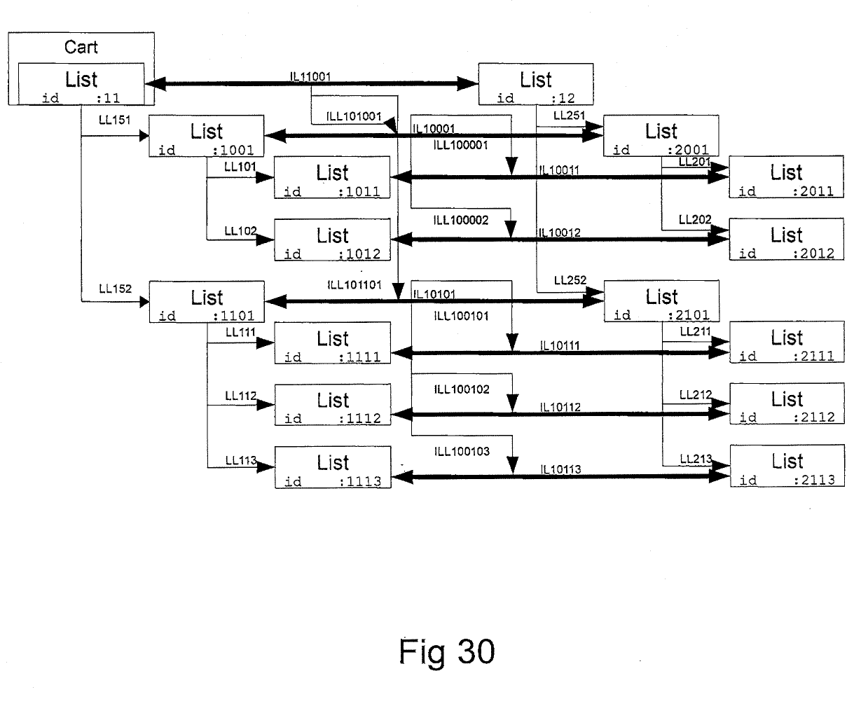

FIG. 30 illustrates that the same occurs for List id 1101 and its descendents, resulting in the links as shown. The InstLink boxes are not shown in the interests of clarity.

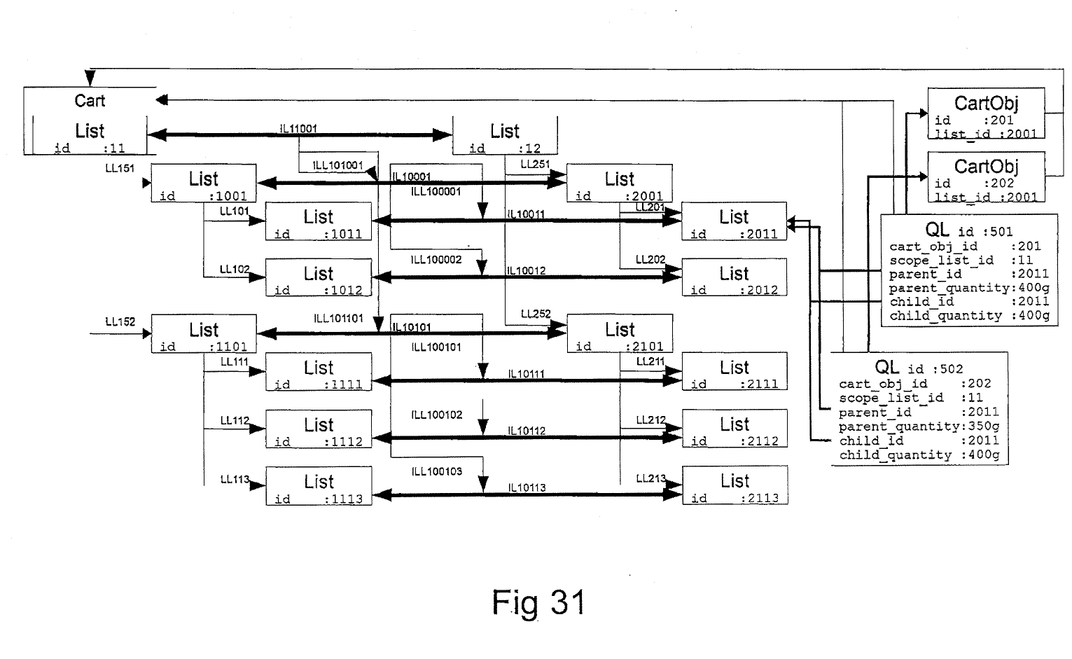

Referring to FIG. 31, the leaf objects are then automatically quantised into purchasable units of cart items. Unit mapping determines that 750 g of List id 2011 is required. Lists id 2011 provides 400 g, so it is quantised as 2×400 g cart items (with 50 g excess). The quantisation is represented as two QuantisationLink (QL) objects (a specialisation of InstLink, including an additional “Cart_obj_id” field), each with scope_list_id a reference to the Cart List id 11 and linking to a specific CartObj. In this example, the QL parent_id and child_id are both the same list id (2011). Examples where quantisation selects different child items will be discussed later. Each QL maps between part or all of the requirements of a leaf List structure and a part or all of a CartObj structure. Each CartObj represents exactly one unit of a purchasable item, of a type determined by the list_id reference. Note that the QL structure includes a scope_filter field. This is used to record the path from the Cart List to the leaf List that the QL applies to. Each unique path has a separate QL object (but a CartObj may be referenced by more than one QL).

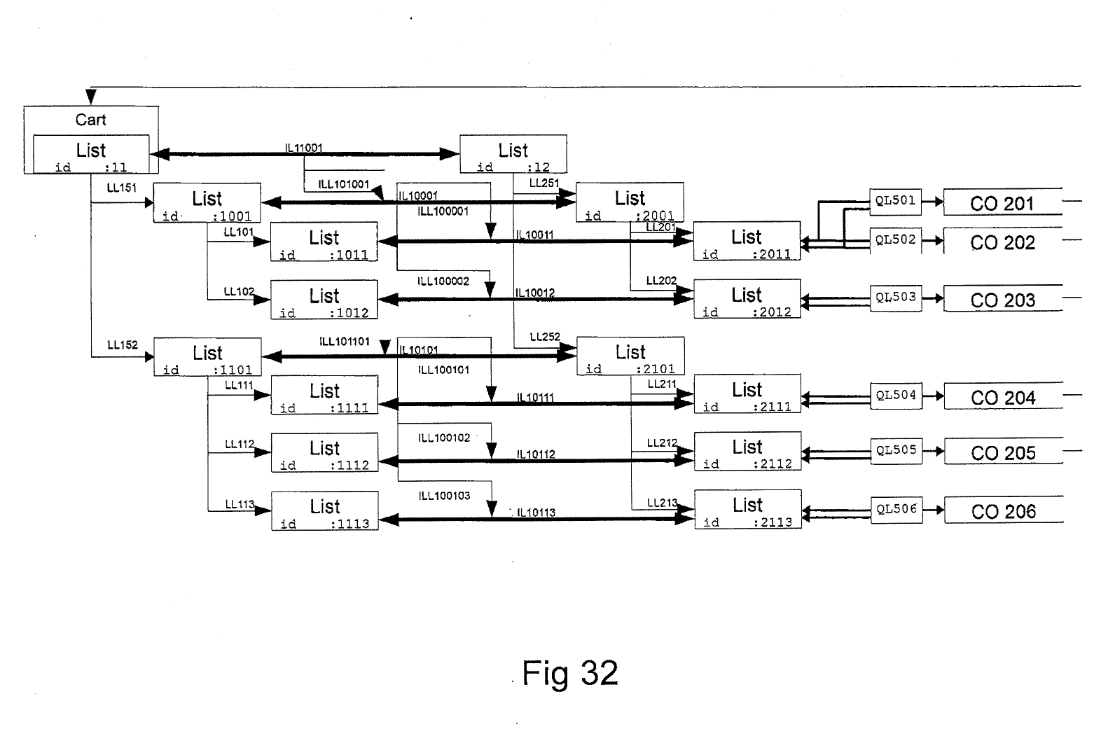

Referring now to FIG. 32, the remaining leaf objects are similarly automatically quantised. Here we assume that each have resulted in a single CartObj (CO) of the same type as the original leaf List for simplicity. The lines from QL objects to the scoping cart List have been omitted for clarity. All QL objects here are scoped to List id 11. Here the set of objects CO 20-206 is the traditional “flat” shopping cart. The other data structures provide the infrastructure to allow high level management of the cart as shown in the following examples.

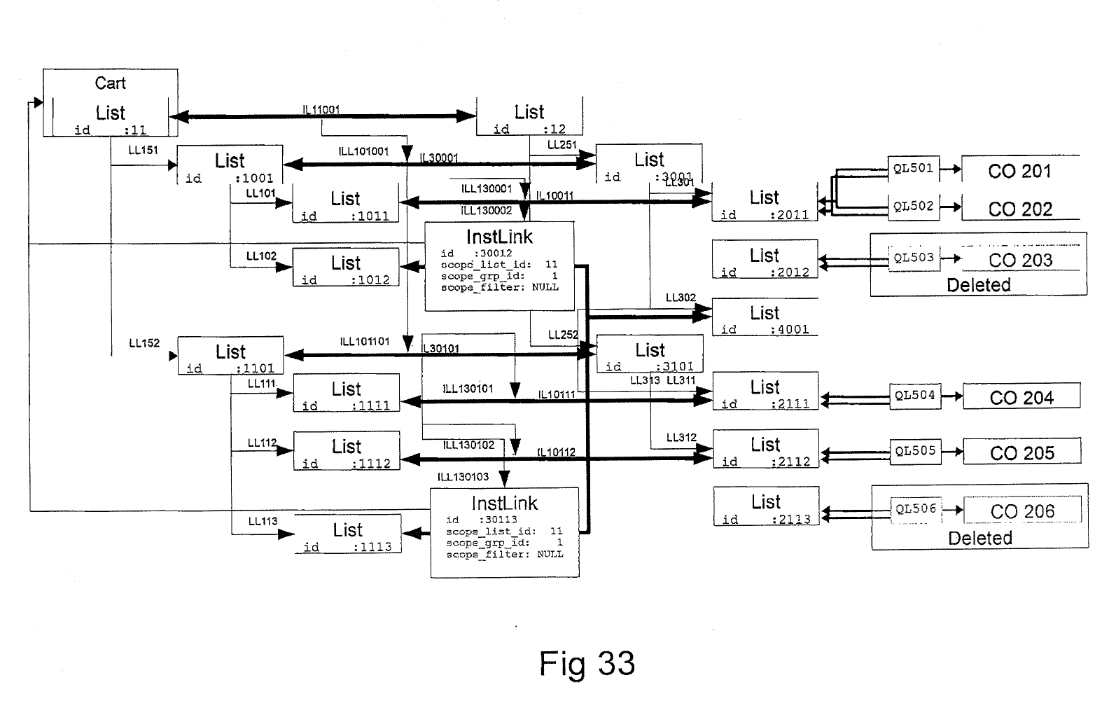

Referring now to FIG. 33, the user decides to group together List id 1012 and List id 1113 so that they are instantiated together as List id 4001, selected as part of the user interaction for grouping. This supersedes (but does not destroy) the InstLinks created earlier (id 10012 and id 10113). However, it does not result in the creation of a new set of InstLink objects (IL3001 and IL3001) at the scope of the parent Lists (id 1001 and id 1101), and new InstLinkLink objects for the new hierarchy. Since the cart scoped InstLink id 11001 is still volatile, it is changed directly, altering the InstLinkLink objects (id 101001 and id 101101) to link to the new InstLink objects. A new List id 3001 and LL301, LL302, and similar List id 3101 and LL311-313 were also created automatically to reflect the new hierarchy. The now obsolete quantisations are deleted.

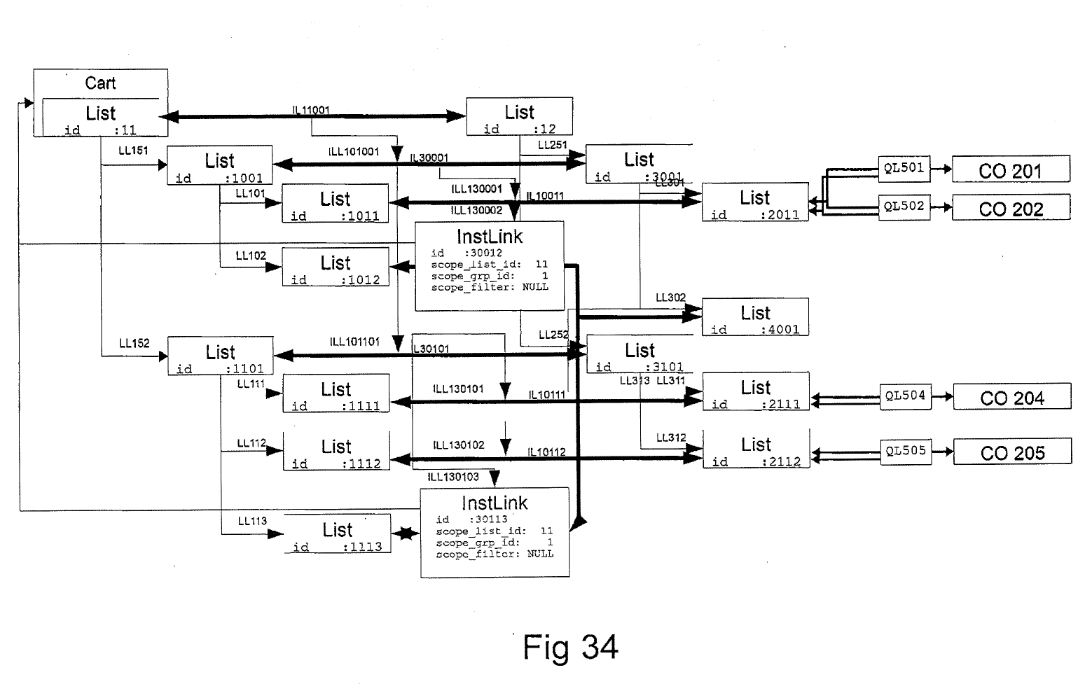

Referring now to FIG. 34, the new list id 4001 is also instantiated automatically. Here the quantisation algorithm has two paths to the List to consider, one by each of the original grouped Lists:

<ILL101001:ILL130002>

<ILLI101101:ILL130103>

Note that here the path is defined by the ILL links. The scope_grp_id values on intermediate (child and parent) IL 30012 and IL 30113 structures will be encountered when traversing the path. Each path can be followed to produce a map chain (by following IL child_list_link_id references to ListLink objects and associated Lists objects).

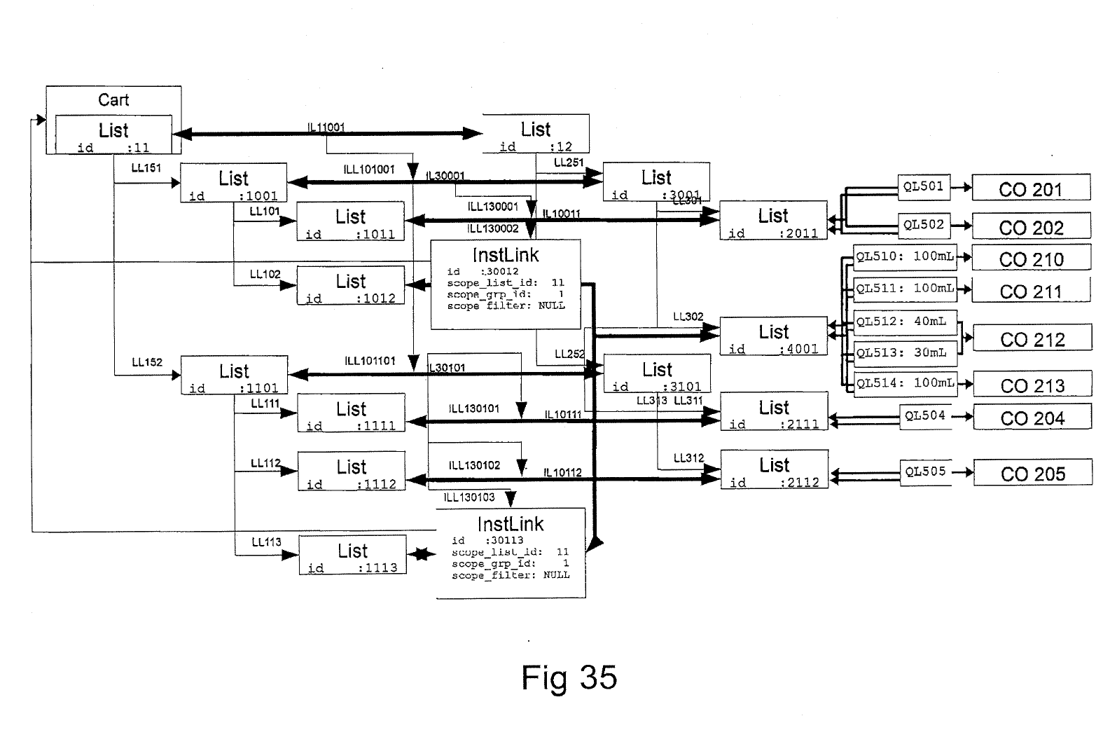

Referring now to FIG. 35, from each path <ILL101001:ILL13002>and <ILL101101:ILL130103>we get a quantity of List id 4001 required (say 240 ml and 130 ml, with List id 3001 providing 100 ml per instance). The paths also provide the information that each path has the same scope_grp_id, which may influence the quantisation algorithm. Shown here is the quantisation result of 5 QL structures mapping 24 Cart Obj instances of List id 3001. This decomposes as 100 ml, 100 ml and 40 ml quantities associated with path 1 and 30 ml and 100 ml quantities associated with path 2. There is QL structure for each <path, cart object> pair. It can be seen that CO 201-211 are purely used for path 1, CO 213 purely for path 2, and CO 212 has grouped remaining requirements from both paths and satisfied them with a single CartObj.

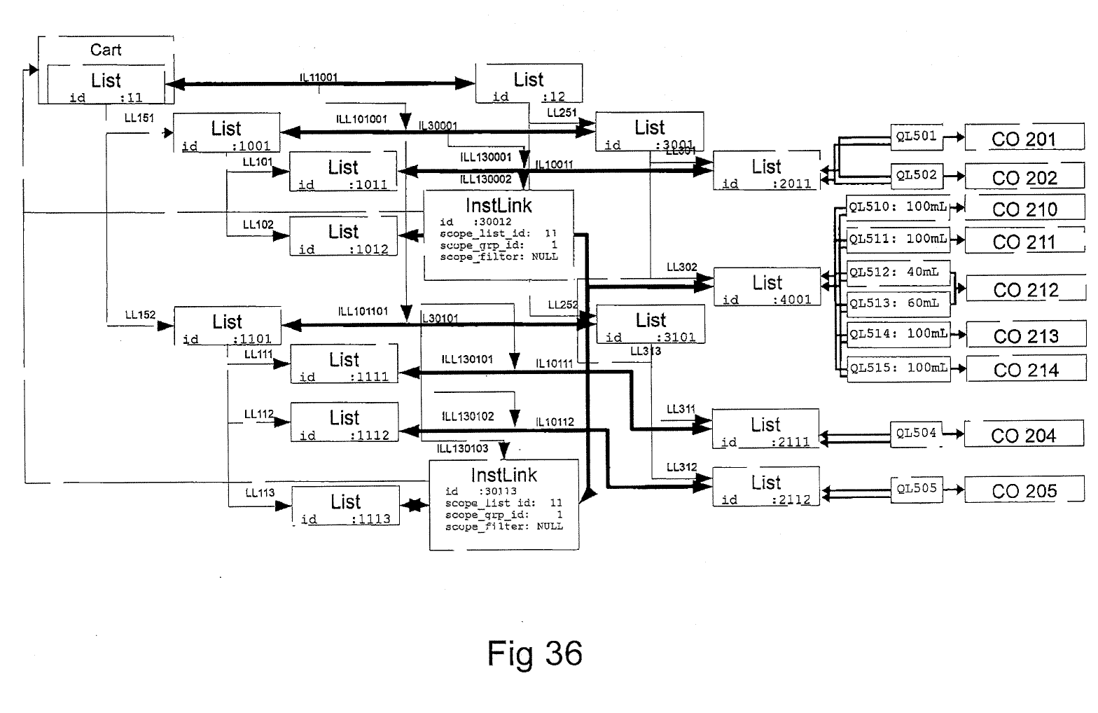

Referring to FIG. 36, the user rescales the quantity of list List id 1102 in the cart, doubling it (the parent_quantity in LL152 and LL252 are double). The amount of List id 2112 and id 2113 required are double. The amount of path 2 to List id 4001 is doubled from 130 ml to 260 ml. Suppose further the QL 504 and QL 505 were already over-provisioned enough for the doubling, mainly quantities of List id 4001 need considering. Quantisiation algorithm takes as input all of the calculated <path, quantity> pairs, plus all the previous QL objects, and outputs a new set of QL and CartObj structures (creating or destroying QL and CartObj structures as required). Here the output set is the same as the input set, with the change that QL513 is now 60 ml, QL516+CO214 is added, and QL504-505 parent quantities are doubled as noted above.

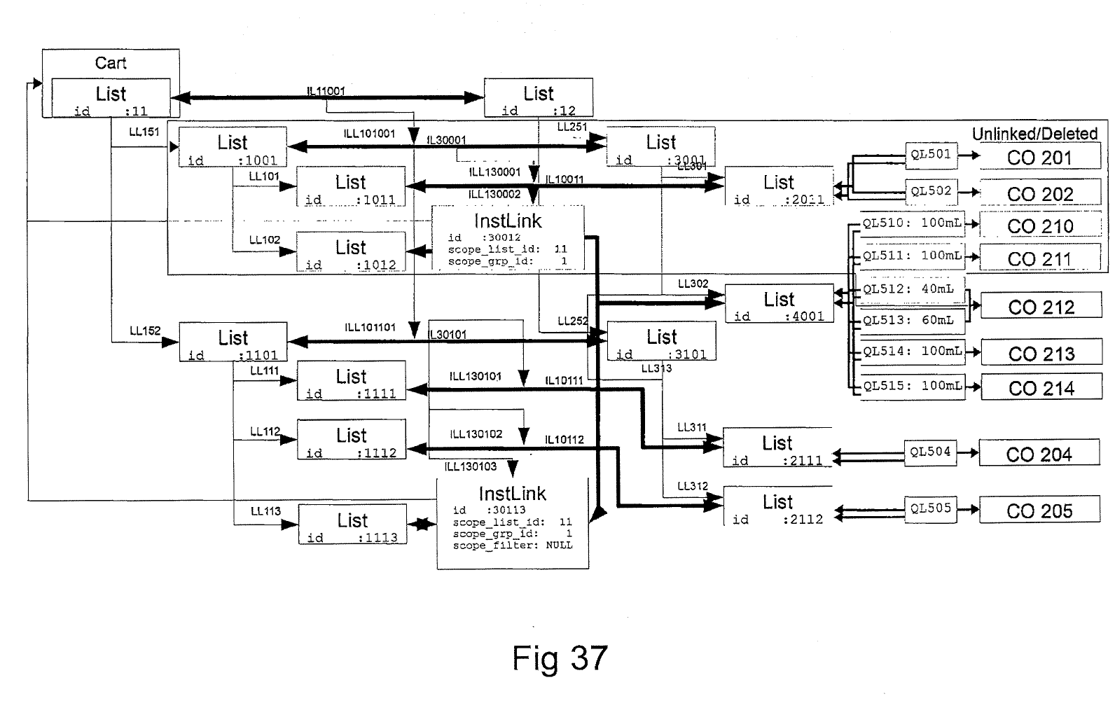

Referring now to FIG. 37, the user removes List id 1001 from the cart. The cart-level objects associated with List id 1001 are deleted (LL151, LL252 and ILL101001). The quantisation algorithm takes as input all of the recalculated <path, quantity> pairs, plus all the previous QL objects, that outputs a new set of QL and CartObj structures (destroying QL and CartObj) structures as shown above). Here the output set is a subset of the input set, with all QL structures for List id 1001 paths removed. The main interesting point is that CartObj id CO212 remains, because it is still in use by QL513 for List id 1101. Not that List id 1001 and List id 4001 still exist and maybe reused (as do IL3001, but they are no longer associated with the Cart List id 11).

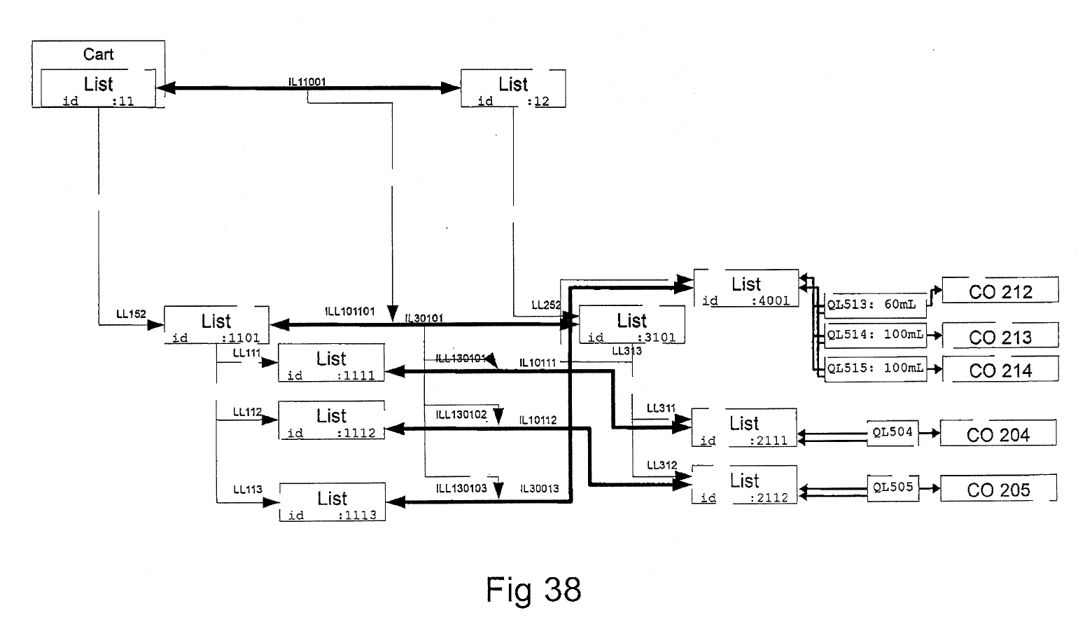

FIG. 38 illustrates the resulting set of structures associated with the current Cart after completing removal of deleted/unlinked structures.

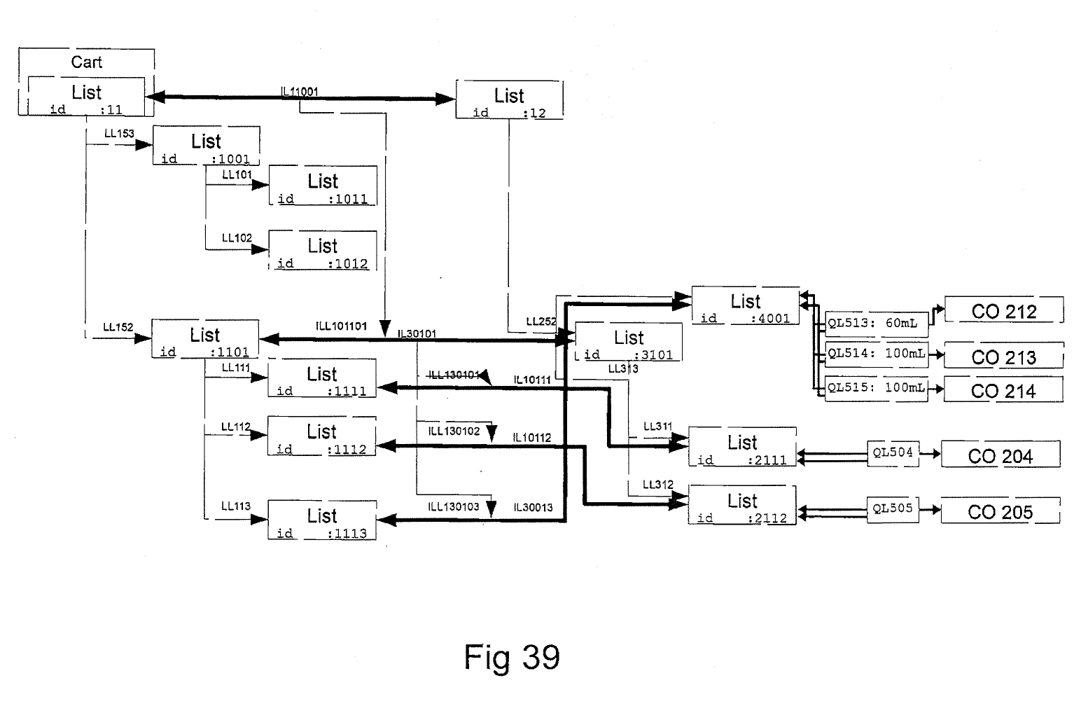

In FIG. 39, the user re-adds List id 1001 to the Cart. The new ListLink id 153 is created, linking the already existing List id 1001 into the Cart List id 11.

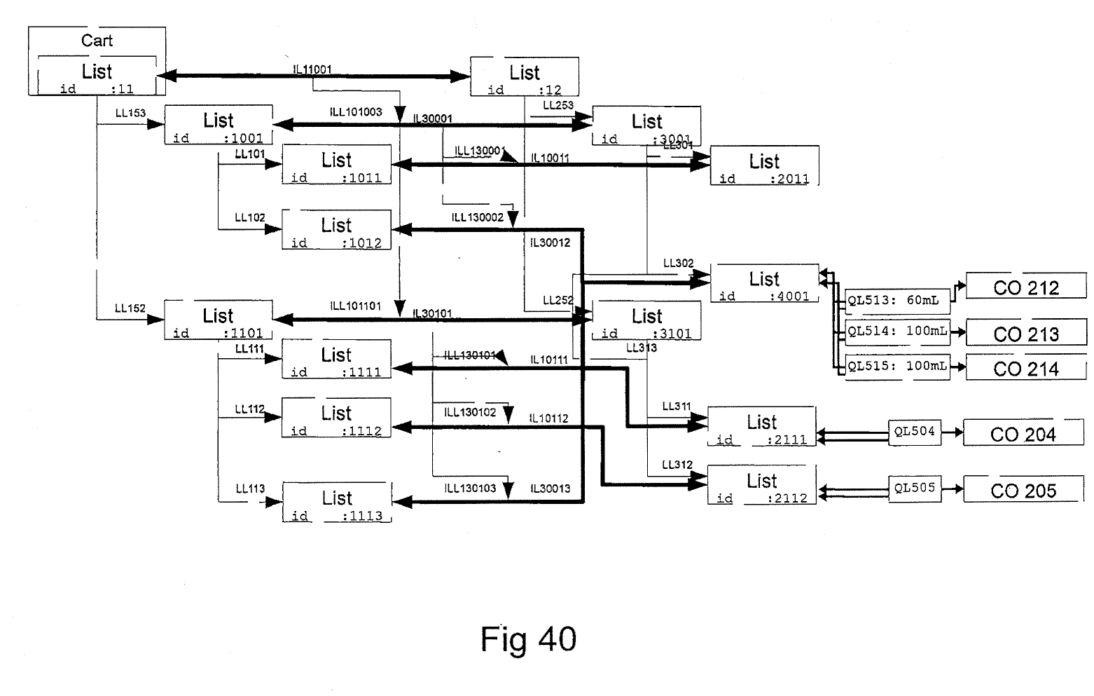

As illustrated in FIG. 40, the List id 1001 is automatically instantiated using the last used InstLink for the <User, List> combination, IL3001 (the user could later select another). ILL101003 and LL253 are created to represent this. This has the result of linking in various Lists, ListLink, InstLink and InstLinkLink structures.

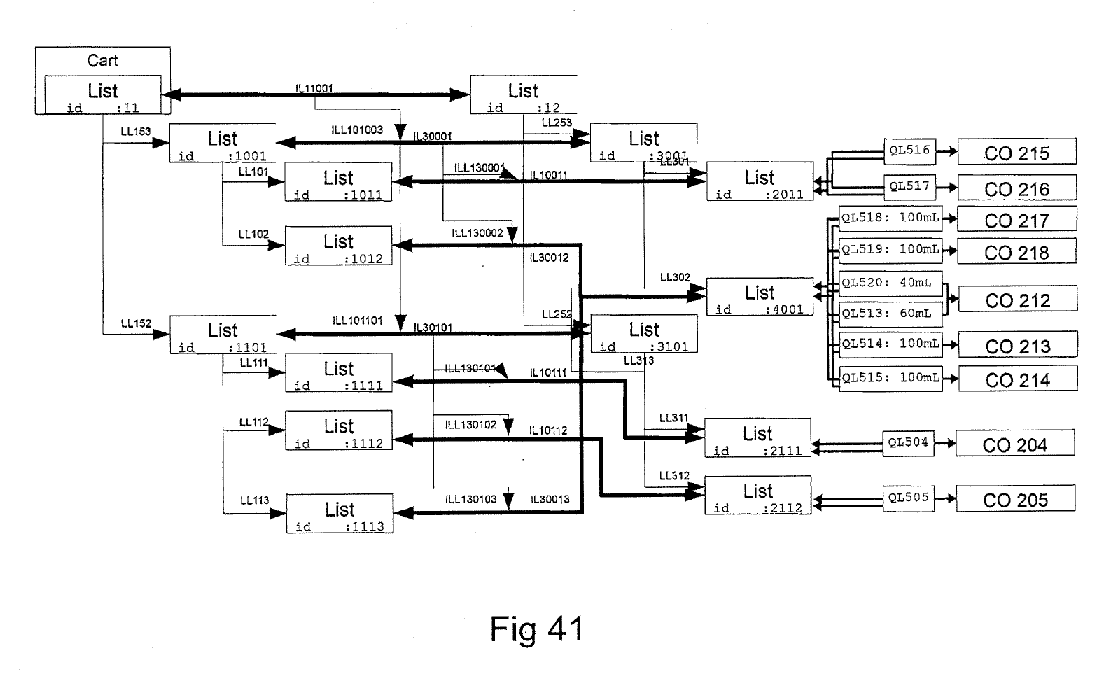

As shown in FIG. 41, finally the quantisation algorithm is re-run to calculate the new set of Cart Objects required, creating and destroying QL and CO structures as required. The end result is the same logical cart contents as at the end of the step illustrated in FIG. 37, but with some different structure identifiers, as some structures were destroyed and recreated with different labels in the processing of the steps illustrated in FIGS. 38 to 41 (move from and re-add to the cart List id 1001).

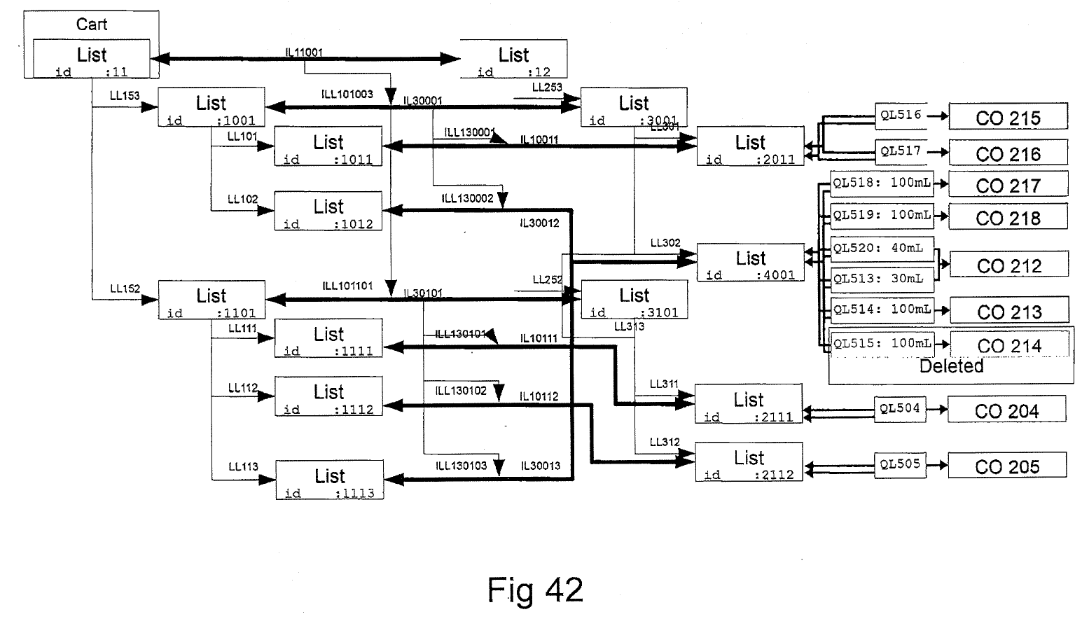

In FIG. 42 the process is illustrated where the user halves the quantity of Lists id 1101 in the Cart (this is the inverse of the step illustrated in FIG. 37). The parent_quantity listed in LL152 and LL252 are halved, and re-running the quantisation algorithm results in removal of a now unnecessary cart item.

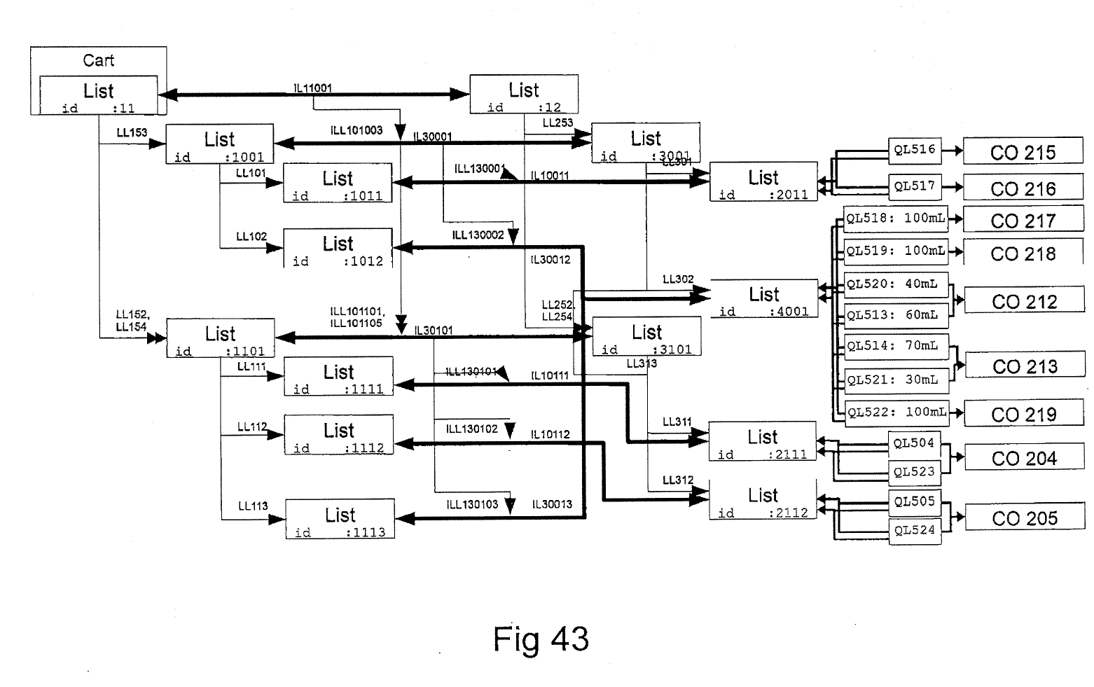

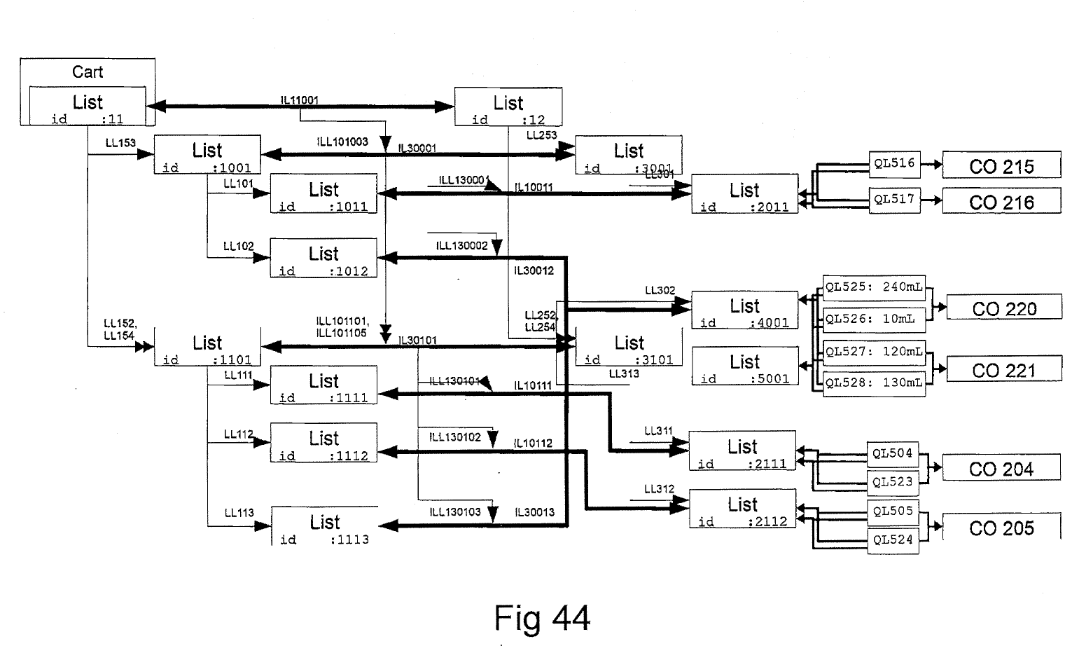

In FIG. 43 the process is illustrated where the user adds a second instance of Lists id 1101 to the cart. This results in a second ListLink id 154 from List id 11 to List id 1101 (this is different from rescaling). The second instance is instantiated in this example using the same InstLink id 30101, but new structures ILL 101105 and LL254 are also added for this distinct instantiation of List id 1101 (user interaction or preferences could map the new instance using a different InstLink, such as IL1001 from the steps illustrated in FIGS. 31 to 33). There are now two paths to quantise for all component items under Lists id 1101. The quantisation results are shown in FIG. 44. It was discussed with reference to FIG. 37 that CO204-205 were over-provisioned. The quantisation algorithm therefore needs only to create QL522-524, CO219 and update QL link quantities for the new partitioning. QL513-514, 504-505 provide quantisations for paths from ILL101101 and QL521-524 and provide quantisation for paths from IL101105.

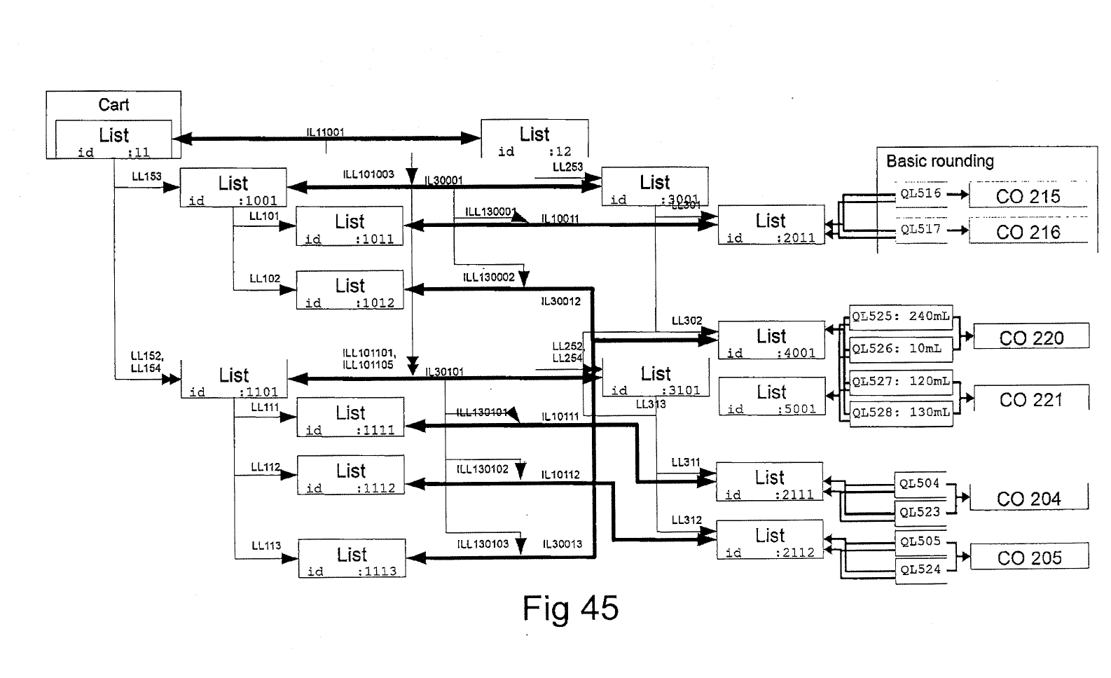

In the process of FIG. 44, the user tweaks their quantisation preferences, in an unspecified manner, resulting in re-quantisation. With the new preferences, the quantisation algorithm determines that rather than simply using five CartObj instances of List id 4001 (providing 5×100 ml in total), it should instead instantiate it as two CartObj instances of a different List id 5001, each providing 250 ml. The resulting structures are shown in FIG. 45. It can be seen that rather than having the QuantisationLink parent_id and child_id point to the same object, the parent_id points to List id 4001 (the list being quantised) and child_id references List id 5001 (the quantisation result).

How the quantisation algorithm arrives at this result will now be discussed with reference to FIGS. 45 to 48.

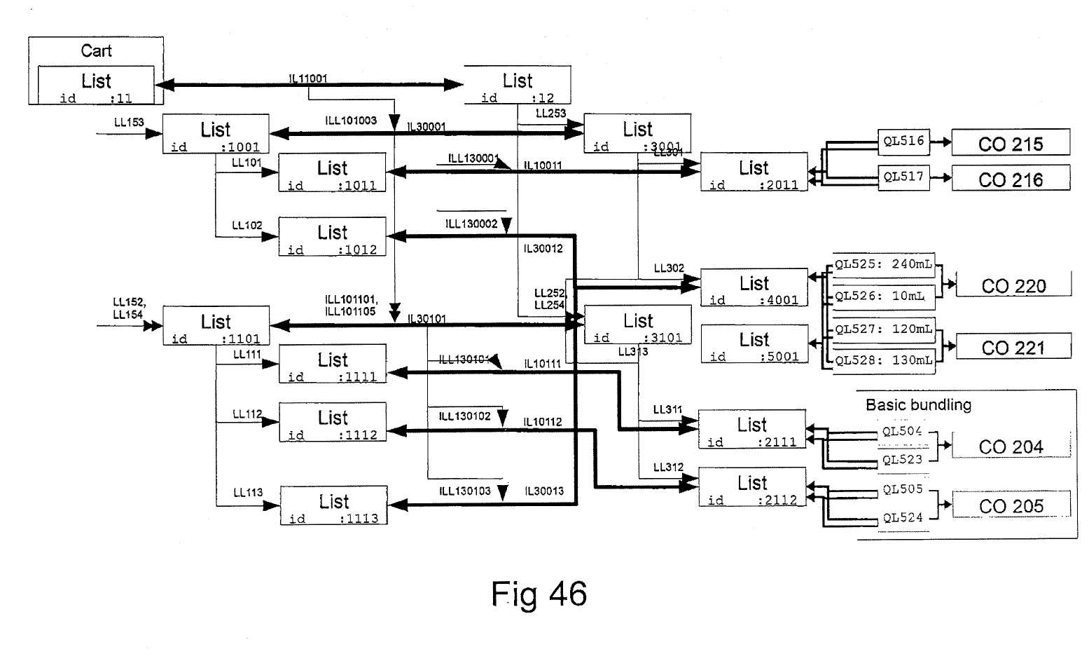

As discussed with reference to FIGS. 31 and 32, the quantisation algorithm takes as input the set of unique paths through the object hierarchy and any previous quantisation results and produces a new updated set of quantisation results. The nature of the algorithm is not prescribed and just about any mapping of inputs to output set is technically valid. Only a subset of possible algorithms would provide interesting or useful results however. A very simple algorithm will initially be considered to which complexity is iteratively added. Alternative algorithms will then be considered. Referring now to FIG. 46, a very basic algorithm will initially be considered. The input set of QL and CO objects are ignored. For each input <path, path_quantity>, it rounds the path_quantity up to a multiple of the provides_quantity for the terminating List in the path. A CartObj is created for each multiple, and QuantisationLink mapping the terminating List to itself (as parent and child references). All but the last QL has parent_quantity matching the provides_quantity for the List, while the final QL has a parent_quantity matching the remainder (path_quantity % provides_quantity), where % is the modulus/remainder operation. This is the sort of quantisation that was discussed with reference to FIG. 31, when 750 g of List id 2011 was quantised as 2×400 g items, using 400 g and 350 g respectively.

Taking the basic algorithm, it is extended to take note of the input set of QL and CO objects. Rather than destroying the input set and creating the input set from scratch, the algorithm instead determines the minimum change set required to produce the correct input from the input object. CO objects are reused if there is an overlap between the input and the output set in terms of CartObj list_id references. QL objects are reused if there is an overlap in <path scope_filter, cart_obj_id> between the input set and the required outputs, after the above CO reuse is taken into account. The reused QL parent_quantity is updated if required.

With reference to FIG. 46, the algorithm is extended to include bundling of requirements for a given List id from multiple paths. Rather than quantising each path separately, the algorithm first evaluates whether to “bundle” requirements from more than one path into a single requirement, which is then quantised. The simplest approach is to always bundle paths if they terminate at the same List (as the paths to List id 4001 do). The total requirement is quantised into CartObj structures and then QL structures are created to partition each path's requirements across the CO structures. More complex bundling approaches could consider information like which groups a path is a member of <scope_list_id, scope_grp_id>, or meta data like “planned use date” and “shelf life”. Once bundling is determined, the same basic quantisation procedure for the bundle as a whole is followed.

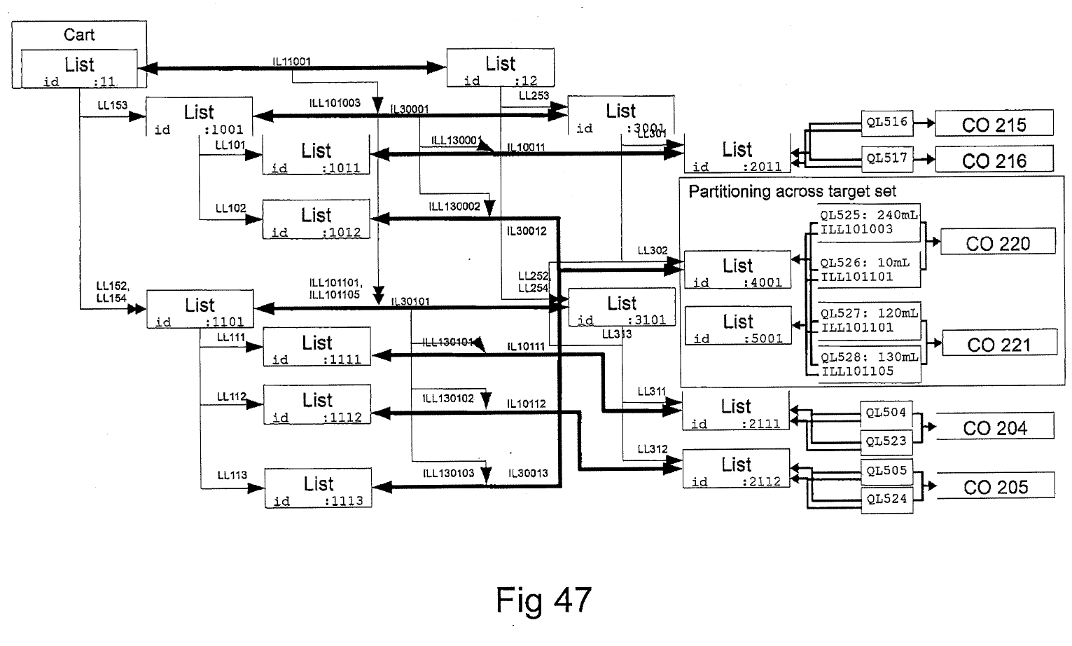

Referring now to FIG. 47, the basic algorithm so far creates only CartObj structures referencing the List being quantised. This is extended so that the quantisation algorithm builds a set of objects considered acceptable substitutes of the List being quantised. In this example, the algorithm finds the set of all InstLink structures with parent_id matching the List id being quantised, with rating_equiv_cost below a configurable threshold. The set of List structures referenced by the child_id parameter of the InstLink structures combined with the original List id give the set of possible items to add to the cart (a target set). The quantisation algorithm then partitions the requirements of the path or bundle of paths across a set of items from the target set. The partitioning mechanism could be simple (minimise number of items) for complex (find a solution then minimising a cost function evaluating various weighted factors like waste, num items and equiv_cost).

The quantisation result shown in FIG. 47 for List id 4001 as two instances of List id 5001 could have been achieved given a target set of {L4001(100 ml), L5001(250 ml)}. Using a partition mechanism that simply tried to minimise the number of items to purchase (to instances of L5001 rather than five instances of L4001). It can be seen that this partitioning represented as the two CO220-221 (each referencing List id 5001 through the CartObj List_id attribute), and the 4 QL 525-528 showing how each path to List id 4001 is split into portions of a CartObj instantiating List id 5001. The path shown is abbreviated to show just one ILL per QL, but that is enough to uniquely identify the QL scope_filter/path among other paths to List id 4001.

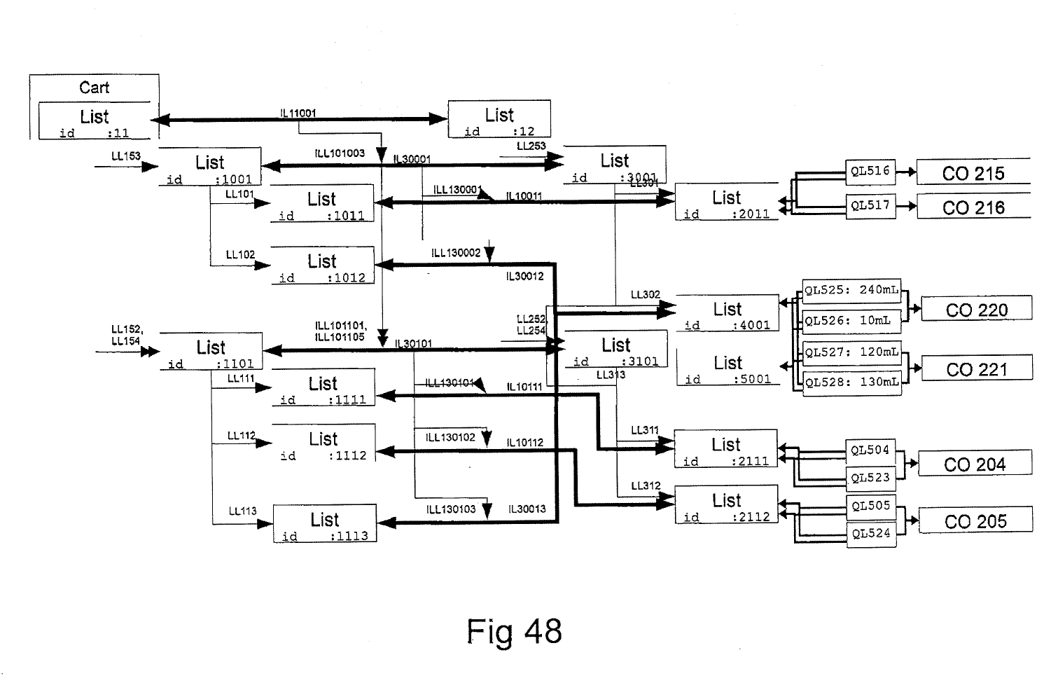

Referring now to FIG. 48, a generalisation of the quantisation algorithm will now be discussed. The quantisation algorithms discussed so far have had a clear separation of processing to determine bundling, target sets and partitioning. The entire quantisation algorithm could just as well be implemented as a genetic algorithm or a neural network bred/trained to minimise some sort of cost function. Alternatively, a mixture of the approaches could be used. Potentially useful meta data that could be used by the algorithm could include various quality measures, both as path “requirements” and as Component Object “attributes”, or component “use by” lifetimes. Meta data used to influence the algorithm is also user-customisable, allowing global averages or other collective intelligence methods e.g. user classification, neural networks, k-nearest-neighbours, or support effective machines, to be used to create “good” quantisation results from the global and per-user history/references.

Another generalisation worth discussing is the bundling of paths that do not terminate at the same List id. A “good” quantisation algorithm could recognise (for example) through the existence of InstLink structures with a low rating_equiv_cost between the List structures in question. That two Lists structures represented similar objects and then bundling them for quantisation could be appropriate. Contrast this with the example in FIGS. 34 to 36 where the user explicitly grouped two items. The quantisation algorithm that aggressively sought out such bundling potential would benefit the user through eliminating the need for explicit interaction in many cases.

Although the present invention has been described herein above with reference to specific embodiments, it would be apparent to a skilled person in the art that modifications were allowed in the spirit and scope of the present invention.

For example, although the detailed embodiment of the invention as been described above with reference to ordering products for the plurality of recipes via a shopping cart, the present invention has much broader applicability to the management of relationships between any form of component and composite article. The present invention has particular applicability to the field of application of ordering items. In such a field, one embodiment of the present invention can relate to the ordering of component parts for a machine such as an automobile or domestic appliance. In such an example, the component parts are parts that can be used in a multiplicity of such composite mechanical devices. The management of the composite articles and components in this way enables a user wishing to order parts for the manufacture or construction of multiple composite articles to change the order either at the component level or at the composite article level or indeed at any intermediate sub-composite article level. For example, where the composite article comprises an automobile, the sub-composite article could comprise a gearbox. Thus a user is able to order a gearbox as a whole, or replace the gearbox with components for the construction of a gearbox, or with a different gear box. Thus it can be seen that the present invention has wide applicability to the management of data representing relationships between components and composite articles.

A user interface to facilitate the management of the data structure relating components and composite articles can be provided in any convenient manner such as by virtue of software implemented on a computer to provide a display and a user input capability such as via a keyboard or pointing device. A user interface can be provided on a computer system in software as a bespoke coded interface, or as a browser based web page interface for example. The interface can be provided on a dedicated computer integrated with the software and hardware providing the functionality, or neural interface can be provided remotely to the software and hardware providing the functionality. In a client server base system, the user interface can be hosted at the server and accessed by the client.

Aspects of the present invention provide a method and system for ordering products from a product provider in which a composite data structure is used defining component data structures for component products of the composite object. The method and system enables simple ordering of products from product providers using the composite data structures or the component data structures. A user interface is provided to enable simple additions, deletions or modifications.

What is claimed is:

1. A computer implemented method of managing component object data represented as a list identifying component physical objects that can be used in a plurality of composite physical objects, the method comprising:
storing composite object data structures in a storage system, each composite object data structure linking data for a composite physical object to a component object data structure for each of a plurality of component physical objects used in the composite physical object;
providing a user interface to display the list of component physical objects and composite object data structures linked to the displayed list of component physical objects to enable a user to select composite object data structures and component object data structures to modify the list, and to enable a user to select stored composite object data structures to form or add to the list;
receiving a user selection of a displayed composite object data structure and modifying the list to remove component physical objects identified by links in the selected composite object data structure;
receiving a user selection of a stored composite object data structure and modifying the list to add component physical objects identified by links in the selected composite object data structure;
receiving a user selection of a component object data structure represented as a component physical object in the list; and, one of:
using a processor to process the composite object data structure linked to the selected component object data structure to identify other component physical objects in the list used in the composite physical object and removing the identified component physical objects from the list; or
modifying the composite object data structure in accordance with the removal or modification of the selected component object structure.

2. A computer implemented method according to claim 1, wherein at least one stored composite object data structure links to at least one other composite object data structure as a daughter composite object data structure to form a hierarchical data structure.

3. A computer implemented method according to claim 2, wherein the user interface displays the hierarchical data structure, a user selection of a displayed daughter composite object data structure is received, and the list is modified to remove component physical objects identified by linking in the selected daughter composite object data structure.

4. A computer implemented method according to claim 1, including storing templates for a plurality of composite object data structures in a template memory, receiving a selection of a template from a user or making an automatic selection of a default template, generating the composite object data structure linked to component object data structures, and storing the generated composite data structures in the storage system.

5. A computer implemented method according to claim 4, including generating and storing a said template in the template memory.

6. A computer implemented method according to claim 1, wherein quantities are included in at least one said composite object data structure and at least one component object data structure, and said list identifies quantities of the or each component physical object for said at least one component object data structure.

7. A computer implemented method according to claim 6, wherein at least one said composite object data structure includes a scaling factor to be applied to at least one component object data structure to scale the quantity identified in the list for said at least one component physical object according to the scaling factor.

8. A computer implemented method according to claim 1, wherein units of measurement are included in at least one said composite object data structure and at least one said component object data structure, and said list identifies the units for the or each component physical object for said at least one component object data structure.

9. A computer implemented method according to claim 8, including storing unit mapping data in a mapping store to map between different units, and using the mapping data to convert units in said at least one composite object data structure and/or said at least one component object data structure

10. A computer implemented method according to claim 1, wherein the list identifies like component physical objects used in a plurality of composite physical objects aggregated together, the method including aggregating like component physical objects in the list when like component physical objects are added to the list, and to disaggregate like component physical objects in the list when like component physical objects are removed from the list.

11. A computer implemented method according to claim 1, including receiving user input to modify at least one component object data structure or at least one composite object data structure to modify the component physical objects on the list.

12. A computer implemented method according to claim 1, wherein the composite object data structures are link listed objects comprising composite objects, said component object data structures are link listed objects comprising component objects, and link data linking the objects is stored in a link data store.

13. A computer implemented method according to claim 12, wherein at least one said component object is instantiated as a commercially available product, and said component object data structures identify at least one commercially available product.

14. A computer implemented method according to claim 13, including using a database of vendor or manufacturer specific products and instantiation rules to instantiate each said component object as at least one vendor or manufacturer specific product.

15. A computer implemented method according to claim 12, including storing user preference data and/or user history data, wherein the instantiation is performed using the stored user preference data and/or user history.

16. A computer implemented method according to claim 1, including automatically substituting at least one component physical object in the list based on substitution rules.

17. A computer implemented method according to claim 1 for ordering products, wherein said list comprises a list of products to be ordered, including ordering the listed products from at least one supplier.

18. The computer implemented method of claim 17, wherein said component object data structure includes data identifying a supplier for at least one listed product.

19. The computer implemented method of claim 17, wherein products considered to be staple products are identified in a staple product store, and the method including identifying staple products in the list.

20. The computer implemented method of claim 19, including automatically removing the identified staple product from the list or identifying the staple product on the user interface to enable a user to select to remove the product from the list.

21. The computer implemented method of claim 17, wherein at least one said composite object data structure includes a date of use of the composite physical object, at least one product in the list has a use by date, and the ordering is made dependent upon the date of use and the use by date.

22. The computer implemented method of claim 17, including storing vendor data identifying at least one vendor or supplier of the products, wherein the ordering is made dependent upon the vendor data.

23. A computer apparatus for managing component object data represented as a list identifying component physical objects that can be used in a plurality of composite physical objects, the computer apparatus comprising:
a data structure store storing composite object data structures in a storage system, each composite object data structure linking data for a composite physical object to a component object data structure for each of a plurality of component physical objects used in the composite physical object;
a user interface apparatus adapted to display the list of component physical objects and composite object data structures linked to the displayed list of component physical objects to enable a user to select composite object data structures and component object data structures to modify the list, and to enable a user to select stored composite object data structures to form or add to the list;
a processor adapted to:
receive a user selection of a displayed composite object data structure and modifying the list to remove component physical objects identified by links in the selected composite object data structure;
receive a user selection of a stored composite object data structure and modifying the list to add component physical objects identified by links in the selected composite object data structure;
receive a user selection of a component object data structure represented as a component physical object in the list; and, one of:
use the composite object data structure linked to the selected component object data structure to identify other component physical objects in the list used in the composite physical object and removing the identified component physical objects from the list; or
modify the composite object data structure in accordance with the removal or modification of the selected component object structure.

24. A computer apparatus according to claim 23, wherein at least one stored composite object data structure links to at least one other composite object data structure as a daughter composite object data structure to form a hierarchical data structure.

25. A computer apparatus according to claim 24, wherein the user interface is adapted to display the hierarchical data structure, and the processor is adapted to receive a user selection of a displayed daughter composite object data structure, and to modify the list to remove component physical objects identified by linking in the selected daughter composite object data structure.

26. A computer apparatus according to claim 23, including a template memory storing templates for a plurality of composite object data structures, and the processor is adapted to receive a selection of a template from a user or make an automatic selection of a default template, to generate the composite object data structure linked to component object data structures, and to store the generated composite data structures in the data structure store.

27. A computer apparatus according to claim 26, wherein said processor is adapted to generate and store a said template in the template memory.

28. A computer apparatus according to claim 23, wherein quantities are included in at least one said composite data structure and at least one component object data structure, and said list identifies quantities of the or each component physical object for said at least one component object data structure.

29. A computer apparatus according to claim 28, wherein at least one said composite object data structure includes a scaling factor to be applied to at least one component object data structure to scale the quantity identified in the list for said at least one component physical object according to the scaling factor.

30. A computer apparatus according to claim 23, wherein units of measurement are included in at least one said composite object data structure and at least one said component object data structure, and said list identifies the units for the or each component physical object for said at least one component object data structure.

31. A computer apparatus according to claim 30, including a mapping store storing unit mapping data to map between different units, wherein said processor is adapted to use the mapping data to convert units in said at least one composite object data structure and/or said at least one component object data structure

32. A computer apparatus according to claim 23, wherein the list identifies like component physical objects used in a plurality of composite physical objects aggregated together, said processor being adapted to aggregate component physical objects in the list when component physical objects are added to the list, and to disaggregate component physical objects in the list when component physical objects are removed from the list.

33. A computer apparatus according to claim 23, wherein said processor is adapted to receive user input to modify at least one component object data structure or at least one composite object data structure to modify the component physical objects on the list.

34. A computer apparatus according to claim 23, wherein the composite object data structures are link listed objects comprising composite objects, and said component object data structures are link listed objects comprising component objects, including a link data store storing link data linking the objects.

35. A computer apparatus according to claim 34, wherein said processor is adapted to instantiate at least one said component object as a commercially available product, and said component object data structures identify at least one commercially available product.

36. A computer apparatus according to claim 35, including a database of vendor or manufacturer specific products, and an instantiation rules store storing instantiation rules, wherein said processor is adapted to instantiate each said component object as at least one vendor or manufacturer specific product.

37. A computer apparatus according to claim 35, including a user store storing user preference data and/or user history data, wherein said processor is adapted to perform the instantiation using the stored user preference data and/or user history.

38. A computer apparatus according to claim 23, wherein said processor is adapted to automatically substitute at least one component physical object in the list based on substitution rules.

39. A computer apparatus according to claim 23, used for ordering products, wherein said list comprises a list of products to be ordered, wherein said processor is adapted to generate an order for the listed products from at least one supplier.

40. The computer apparatus of claim 39, wherein said component object data includes data identifying a supplier for at least one listed product.

41. The computer apparatus of claim 40, including a staple product store to identify products considered to be staple products, wherein said processor is adapted to identify staple products in the list using the staple product store.

42. The computer apparatus of claim 41, wherein said processor is adapted to automatically remove the identified staple product from the list or identify the staple product on the user interface to enable a user to select to remove the product from the list.

43. The computer apparatus of claim 40, wherein at least one said composite object data structure includes a date of use of the composite physical object, at least one product in the list has a use by date, and said processor is adapted to make the ordering dependent upon the date of use and the use by date.

44. The computer apparatus of claim 40, including a vendor data store storing vendor data identifying at least one vendor or supplier of the products, wherein said processor is adapted to make the ordering dependent upon the vendor data.

45. A storage medium storing computer readable code for controlling a computer to carry out a method of managing component object data represented as a list identifying component physical objects that can be used in a plurality of composite physical objects, the code comprising:
code for controlling a computer to store composite object data structures in a storage system, each composite object data structure linking data for a composite physical object to a component object data structure for each of a plurality of component physical objects used in the composite physical object;
code for controlling a computer to provide a user interface to display the list of component physical objects and composite object data structures linked to the displayed list of component physical objects to enable a user to select composite object data structures and component object data structures to modify the list, and to enable a user to select stored composite object data structures to form or add to the list;
code for controlling a computer to receive a user selection of a displayed composite object data structure and modifying the list to remove component physical objects identified by links in the selected composite object data structure;
code for controlling a computer to receive a user selection of a stored composite object data structure and modifying the list to add component physical objects identified by links in the selected composite object data structure;
code for controlling a computer to receive a user selection of a component object data structure represented as a component physical object in the list; and, one of:
code for controlling a computer to process the composite object data structure linked to the selected component object data structure to identify other component physical objects in the list used in the composite physical object and removing the identified component physical objects from the list; or
code for controlling a computer to modify the composite object data structure in accordance with the removal or modification of the selected component object structure.
